(19) United States
(12) Patent Application Publication
(10) Pub. No.: US 2007/0239366 A1
(43) Pub. Date: Oct. 11, 2007

(54) HYBRID CLASSICAL-QUANTUM COMPUTER ARCHITECTURE FOR MOLECULAR MODELING

(76) Inventors: Jeremy P. Hilton, Vancouver (CA); Geordie Rose, Vancouver (CA)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/747,875

(22) Filed: May 11, 2007

Related U.S. Application Data
(63) Continuation of application No. 11/146,743, filed on Jun. 6, 2005.
(60) Provisional application No. 60/577,415, filed on Jun. 5, 2004.

(51) Int. Cl. G06F 17/12; G06G 7/58

(52) U.S. Cl. 702/27; 703/11

(57) ABSTRACT

A method of simulating a molecular system using a hybrid computer is provided. The hybrid computer comprises a classical computer and a quantum computer. The method uses atomic coordinates \vec{R}ₙ and atomic charges Zₙ of a molecular system to compute a ground state energy of the molecular system using the quantum computer. The ground state energy is returned to the classical computer and the atomic coordinates are geometrically optimized on the classical computer based on information about the returned ground state energy of the atomic coordinates in order to produce a new set of atomic coordinates \vec{R}′ₙ for the molecular system. These steps are optionally repeated in accordance with a refinement algorithm until a predetermined termination condition is achieved

### CROSS REFERENCE TO RELATED APPLICATIONS

This application is a continuation of co-pending U.S. patent application Ser. No. 11/146,743 filed Jun. 6, 2005, which claims benefit, under 35 U.S.C. § 119(e), of U.S. Provisional Patent Application No. 60/577,415 filed on Jun. 5, 2004 which are hereby incorporated by reference in their entirety.

### 1. FIELD OF THE INVENTION

The present invention relates to quantum computing. More specifically, the present invention relates to the application of a quantum computer to molecular modeling, and a hybrid classical-quantum architecture to accomplish this task.

### 2. BACKGROUND OF THE INVENTION

### 2.1 Motivation

There is a need in molecular biology and chemistry to model atomic and molecular systems. Moreover, there is value in modeling large systems with greater accuracy and/or more speed than is currently possible even with the most advanced supercomputers. Problems of interest in this field include calculating the ground-state coordinates of atoms in a molecule, calculating the ground-state energy of a molecule given a particular set of atomic coordinates, and predicting which chemical compounds are likely to bind with a high degree of affinity to a target receptor (e.g., a protein).

The behavior of a physical system is most accurately determined by solving equations based on the principles of quantum mechanics, termed QM, a task that is computationally difficult on a classical computer. As used herein, a classical computer is a computer that represents information by numerical binary digits known as “bits,” where each bit has a value of “0” or “1.” For example, the digital computer time and memory resources required to simulate a physical system on a quantum mechanical basis scales exponentially with the number of electrons in a molecule. Almost all problems of practical interest are many-electron systems, for which classical computers do not have the necessary physical resources to solve.

The general problem of finding the naturally occurring three-dimensional structure of a molecule given its chemical composition includes the problem of finding the natural ground state of the structure. For example, identifying the naturally occurring three-dimensional structure of a protein given its sequence of amino acids is known as the protein folding problem and is one of the fundamental problems in biophysical science. See, for example, Chan and Dill, 1993, Physics Today, pp. 24-32, which is incorporated herein by reference in its entirety. The naturally occurring structure of a molecule is believed to be the structure that minimizes or nearly minimizes the total energy of the chain in question. Finding this minimum energy configuration is a difficult and expensive “global optimization” problem, which comprises finding the lowest local minimum (the lowest point within some region around itself) of a function that potentially has many different local minima. The molecular structure problems are difficult global optimization problems because they can have a large numbers of local minima, each being difficult to find, and many of them having energy values close to that of the global minimum.

Determining the behavior of a physical system (e.g., the naturally occurring three-dimensional structure of a molecule given its chemical structure) by solving the equations of QM is computationally difficult. The structure of QM it such that a system with N electrons requires the solution of 4^{N} coupled linear ordinary differential equations (ODEs). This scaling restricts the size of systems that can be described to those with a small numbers of electrons. For example, the solution of the QM equations for acetylsalicylic acid (aspirin), with 102 electrons, would require solving 4¹⁰²≈10⁶¹ coupled ODEs. Performing this task is not possible using conventional computers, as physical resources sufficient to solve this many equations do not exist.

Determining the properties and behavior of atomic and molecular systems computationally by a direct solution of QM equations would be of great value. However, because of the technical challenge of using QM due to the exponentially large number of ODEs that need to be solved, it is not possible to directly solve QM equations for macromolecules such as proteins and nucleic acids of appreciable size (e.g., greater than 150 Daltons) using conventional computers, regardless of their particular performance characteristics. In particular, the scope of computationally tractable problems is currently restricted to molecules having less than thirty electrons. In order to overcome the scaling problems of the full QM equations, algorithms that approximate the true behavior of many-electron systems have been developed. As will be described in Section 2.2 below, many of these algorithms are quite sophisticated, but nevertheless involve some truncation of the full QM equations, if not wholesale substitution of such QM equations with parameterized based approximations. Any truncation of the full QM equations can unpredictably remove vital components of the behavior and properties of the system.

### 2.2 Known Approaches

Significant work has gone into increasing the efficiency of molecular modeling methods for applications such as protein-ligand docking simulations. For example, U.S. Pat. No. 6,226,603 to Freire et al., entitled “Method for the Prediction of Binding Targets and the Design of Ligands,” hereby incorporated by reference in its entirety, describes an algorithm for identifying the location or identity of natural binding sites on a protein, termed active sites, using a high resolution structure of the protein. The algorithm further determines the identity of ligands that can potentially bind to those active sites. However, the algorithm relies on conventional algorithms such as the predicted Gibbs free energy of binding of each atom in the protein structure in order to identify binding sites and predict protein-ligand binding energies. Such methods are limited in their accuracy and are resource-intensive.

There are a number of additional programs and algorithms in the art. For example, Affinity (Accelrys, Inc., San Diego Calif.) is a docking-program that computes interactions between bulk (non-flexible) and moveable atoms using a molecular mechanical/grid (MM/Grid) approximation method developed by Luty et al., 1995, J. Computational Chemistry 16, 454-464, hereby incorporated by reference in its entirety, while interactions among moveable atoms are treated using a full force field representation.

AutoDock (The Scripps Research Institute, La Jolla, San Diego) is a suite of automated docking tools designed to predict how small molecules, such as substrates or drug candidates, bind to a receptor of known three-dimensional structure. The program uses a free-energy scoring function that is based on a linear regression analysis, the AMBER force field, and a large set of diverse protein-ligand complexes with known inhibition constants. See, for example, Morris et al., 1998, J. Computational Chemistry 19, 1639-1662, which is hereby incorporated by reference in its entirety.

Still another program is DockVision (University of Alberta). DockVision computes binding energies using a pairwise calculation between atoms in the ligand and the protein with terms for van der Waals and electrostatics. A distance cutoff is employed and atoms in both the ligand and the protein are organized into charge groups. Intramolecular energies for the ligand are optional. If they are not employed, a simple steric clash detection algorithm is used to ensure that the ligand conformation does not become unreasonable. Two force fields are used by DockVision, namely “Research” and “MMFF94.” The MMFF94 force field is described in Halgren, 1996, J. Computational Chemistry 17, 490-519, hereby incorporated by reference. The Research force field uses a Lennard-Jones 6-12 function together with a standard electrostatic function. All charge groups are neutralized to reduce long range ionic interactions. Intramolecular energies include torsion and van der Waals terms and no electrostatic terms are included. A dielectric constant of 1.0 is used. Charges and atom types for the ligand and protein are automatically assigned within the program.

Still another program for receptor-ligand docking is FRED (OpenEye, Sante Fe, N. Mex.), which provides docking features using Gaussian potentials. Another docking program is FlexiDock (Tripos, Saint Lois, Mo.) which uses a subset of the Tripos force field including the van der Waals, electrostatic, torsional and constraint energy terms, in order to calculate the energy of the important atoms in a protein. Still another program for protein-ligand docking is FlexX (BioSolveIT GmbH, Germany) which computes protein-ligand binding energies using a force field in which the protein receptor is treated as a rigid body. See, for example, Leach et al., 1992, J. Computational Chemistry 13, 730; Klebe et al., 1994, J. Comput.-Aided Mol. Design. 8, 582, Moon et al., 1992, Proteins 11, 314; Rarey et al., 1998, Proteins 34, 17; Berstein et al., 1997, J. Mol. Biol. 112, 535; and Kramer et al., 1999, Proteins 37, 228-241, each of which is hereby incorporated by reference in its entirety.

Still another program for receptor-ligand docking is GLIDE (Schrödinger GmbH, San Diego, Calif.), which stands for Grid-based Ligand Docking with Energetics. See, for example, Eldridge et al., J. Comput. Aided Mol. Des. 1997, 11, 425-445, which is hereby incorporated by reference in its entirety. GLIDE uses a scoring function to rank the receptor binding potential of individual members of a ligand library. Still other programs include, but are not limited to, GOLD (Cambridge Crytallographic Data Centre, Cambridge, England), HINT! (Virginia Commonwealth University), LigPlot (University College of London), Situs (Scripps Research Institute, La Jolla, Calif.), and Vega (Milan University), DOCK (University of California, San Francisco, Molecular Design Institute), GRAMM (SUNY, N.Y.), and ICM-Dock (MolSoft LLC, La Jolla, Calif.).

While each of the foregoing programs are very useful, they have the drawback of not using the complete quantum mechanical energy description of the receptor-ligand complex in order to predict the binding energy between the receptor (e.g., protein) and the ligand. Many of the foregoing programs rely on molecular mechanical force fields. Such force fields represent estimates of the complete quantum mechanical energy description of the receptor-ligand complex and have been developed by careful parameterization of known systems. For example, some force fields have been parameterized using spectroscopic values (e.g., electron diffraction) which provide mean distances between atoms averaged over vibrational motion at room temperature. See, for example, Leach, Molecular Modeling Principles and Applications, 2001, Second Edition, Prentice Hall Publications, which is hereby incorporated by reference in its entirety. An exemplary force field is AMBER 4.1, described in Cornell et al., 1995, J. Am. Chem. Soc. 117, 5179, hereby incorporated by reference in its entirety. AMBER was originally parameterized against a limited number of organic systems. AMBER is used to provide approximations of gas-phase model geometries, solvation free energies, vibrational frequencies, and conformational energies. Still another force field used in the art is CHARMM22, described in Mackerall and Karplus, 1995, J. Am. Chem. Soc. 117, 11946-11975, which is hereby incorporated by reference in its entirety. CHARMM is the Chemistry at HARvard Macromolecular Mechanics force field, and was parameterized by experimental data. It has been widely used for simulations ranging from small molecules to solvated complexes of large biological macromolecules. CHARMM provides estimates for interaction and conformational energies, geometries, local minima, time-dependent behavior, barriers to rotation, vibrational frequencies, and free energy. CHARMM uses the energy function:
E(pot)=E(bond)+E(angle)+E(torsion)+E(out of plane angle)+E(elec)+E(van der Waals)+E(constraint)+E(user defined)
where out of plane angle is defined as an improper torsion. The van der Waals term is derived from rare-gas potentials, and the electrostatic term can be scaled to mimic solvent effects. Unlike AMBER, hydrogen-bond energy is not included as a separate term like in AMBER. Instead, hydrogen-bond energy is implicit in the combination of van der Waals and electrostatic terms. Still another force field used in the art is MMFF94, which is described in Halgren, 1996, J. Computational Chemistry 17, 490-586, hereby incorporated by reference in its entirety. MMFF94 was developed through ab initio approximation techniques using quantum-mechanical principles and verified by experimental data sets.

In summary, force fields and other methods for computing receptor-ligand scoring functions have been devised in the art. Some such force fields do employ quantum mechanical calculations independent of any experiment other than the determination of fundamental constants. Such methods are based on the use of the full Schrödinger equation to treat all the electrons of a chemical system. However, because of computational constraints, approximations are necessary to restrict the complexity of the electronic wave function and to make its calculation possible. This is particularly the case when the system under study is the interaction of a potential ligand to a macromolecular receptor.

### 2.3 Quantum Computing

In 1982, Feynman introduced the idea of a “quantum simulator”: a quantum system that could be used to simulate other quantum systems efficiently. See Feynman, 1982, “Simulating Physics with Computers,” International Journal of Theoretical Physics 21, p. 467, which is hereby incorporated by reference in its entirety. Soon thereafter it was determined that a quantum system could be used to yield potentially exponential time saving results for certain types of computations. See, for example, Deutsch, 1985, “Quantum Theory, the Church-Turing Principle and the Universal Quantum Computer,” Proceedings of the Royal Society of London A 400, p. 97, which is hereby incorporated by reference in its entirety.

### 2.4 Superconducting Qubits and Requirements for Quantum Computing

One physical realization of a quantum computer is based on quantum bits, or “qubits.” Generally speaking, a qubit is a well-defined physical structure that (i) has a plurality of quantum states, (ii) can be isolated from its environment and (iii) permits quantum tunneling between two or more quantum states associated with the qubit. There are many types of implementations of qubits of which superconducting qubits are just one. Implementations of qubits include ion traps, cavity quantum electrodynamics (QED), nuclear magnetic resonance (NMR), quantum dots, silicon-based, electrons-on-helium, and optical. See, for example, Mooij et al., 1999, Science 285, 1036, which is hereby incorporated by reference in its entirety. A survey of the current physical systems from which qubits can be formed is found in Braunstein and Lo (eds.), 2001, Scalable Quantum Computers, Wiley-VCH Verlag GmbH, Berlin (republication of a portion of volume 48 of Fortschritte der Physik), which is hereby incorporated by reference in its entirety and is referred herein as Braunstein and Lo.

In order for a physical system to behave as a qubit, a number of requirements must be satisfied. See DiVincenzo, 2000, “The Physical Implementation of Quantum Computation,” Fortschritte der Physik 48, pp. 771-783, which is hereby incorporated by reference in its entirety. The five requirements for the implementation of quantum computation are:
i) a scalable physical system with well characterized qubits;
ii) the ability to initialize the state of the qubits to a simple fiducial state, such as |000 . . . >;
iii) long relevant decoherence times, much longer than the gate operation time;
iv) a “universal” set of quantum gates; and
v) a qubit-specific measurement capability (the need to be able to measure the state of the qubit in order to retrieve information).

The ability to perform operations that initialize, control, and couple the qubit is required for a qubit to be useful in quantum computing. Control of a qubit includes performing single qubit operations as well as operations on two or more qubits. In order to support quantum computing, this set of operations (gates) is typically a universal set. A universal set of quantum operations is any set of quantum operations that permits all possible quantum computations. Many sets of gates (operations) are universal. One example of a set of gates that is universal is the complete set of single qubit gates plus a CNOT gate. See, for example, Barenco et al., 1995, Physical Review A 52, 3457-3467; Dodd et al., 2002, Physical Review A 65, 040301; and Nielsen and Chuang, 2000, Quantum Computation and Quantum Information, Section 4.5, pp. 188-200, each of which is hereby incorporated by reference in its entirety.

### 2.5 Quantum Computing Hardware Proposals

Several quantum computing hardware proposals have been made. Of these hardware proposals, one of the most scalable types of physical systems appear to be those that are superconducting structures. Superconducting material is a material that has no electrical resistance below critical levels of current, magnetic field and temperature. Josephson junction based qubits are examples of devices made using superconducting materials.

Materials that exhibit superconducting properties are candidates for quantum computing applications, since the quantum behavior of the Bose condensates (Cooper pairs) at Josephson junctions within such superconducting materials have macroscopically observable variables. There are two principal ways to form superconducting qubits. One way corresponds to the limits of well-defined charge (charge qubit). The other way corresponds to the limits of well-defined phase (phase qubit). Phase and charge are related variables that, according to quantum mechanical principles, are canonical conjugates of one another. Superconducting qubits can be classified as charge qubits or phase qubits based on the Josephson energy of the Josephson junctions in such qubits. In phase qubits, the Josephson energy E_{J} is significantly larger, e.g., in some embodiments 10 times, between 10 to 100 times, or greater than 100 times larger, than the charging energy Ec. In charge qubits, the charging energy E_{C} is significantly larger than the Josephson energy E_{J}. See Makhlin et al., 2001, Reviews of Modern Physics 73, pp. 357-491, which is hereby incorporated by reference in its entirety. Superconducting qubits include devices that are well known in the art, such as Josephson junctions. See, e.g., Barone and Paternò, 1982, Physics and Applications of the Josephson Effect, John Wiley and Sons, New York; Martinis et al., 202, Physical Review Letters 89, 117901; and Han et al., 2001, Science 293, pp. 1457-1460, each of which is hereby incorporated by reference in its entirety.

More recently, superconducting qubits that share the properties of both charge and phase qubits have been proposed. See, for example, U.S. Pat. No. 6,838,694 B2 entitled “Superconducting Quantum-Bit Device Based on Josephson Junctions,” and U.S. Patent Application Publication No. 2005/0082519 A1, “Charge-Phase Qubits,” each of which is hereby incorporated by reference in its entirety.

Other proposals for qubit implementations include ion traps, and nuclear spin-based qubits implemented using well-developed silicon technology. See, for example, U.S. Pat. No. 5,793,091, entitled “Parallel Architecture for Quantum Computers Using Ion Trap Arrays,” and U.S. Pat. No. 6,472,681, entitled “Quantum Computer,” each of which is hereby incorporated by reference in its entirety.

As discussed above, in order to carry out quantum computing, a physical system containing a collection of qubits is needed. A qubit is a quantum two-level system represented by qubit states denoted as |0> and |1>. The feature that distinguishes a qubit from a bit is that, according to the laws of quantum mechanics, the permitted states of a single qubit occupy a two-dimensional complex vector space. In particular, the general state of a qubit is written a|0>+b|1>, where a and b are complex numbers. Thus, a classical computer (CC) is one that represents information as binary bits having the values “0” and “1” whereas a quantum computer (QC) is one that represents information using a two-dimensional complex vector space. A QC is a computer that stores or manipulates information in a quantum mechanical fashion. This allows a QC to simulate a physical system with quantum properties more efficiently than a CC can. The QC is more efficient than the CC because the QC is a type of analog computer. Specifically, the storage and evolution of data under a QC can occur by quantum mechanical rules, with QM effects such as superposition, states having phases, entanglement, tunneling, etc. The general state of two qubits, a|00>+b|01>+c|10>+d|11> is a four-dimensional state vector, one dimension for each distinguishable state of the two qubits. The general state of n qubits is therefore specified by a 2ⁿ-dimensional complex state vector. For more information on qubits, see Braunstein and Lo.

### 2.6 Coherence Requirement

The quantum mechanical properties of a qubit are easily affected by interactions between the qubit and the environment (e.g., other systems). Yet quantum computing requires that the qubits be isolated from such interactions so that the state of the qubit can coherently evolve in accordance with the quantum gates applied to the qubits. Despite the requirement for isolation so that the qubits can evolve, universal quantum computing still requires some control over (interaction with) the qubit so that fundamental operations such as qubit initialization, gate application, and qubit state measurement can be effected. This apparent contradiction between the need for isolation and the need for control over the qubit is a direct result of the quantum behavior of qubits.

The need for isolated qubits that nevertheless can be controlled has presented numerous fabrication and design challenges. Such challenges have included identification of methods for initialization, control, coupling and measurement of qubits. Systems and methods for addressing these challenges are being investigated. In particular, systems in which qubits can be controlled and measured in ways that do not perturb their internal quantum states are being sought.

Devices that include multiple controllable qubits that permit classical readout operations to be performed are central to the goal of building a quantum computer. To date, many known systems and methods for coupling model qubits in simulated quantum computing devices have been unwieldy and generally unsatisfactory. Such systems and methods are based on optics (entanglement of photons) or nuclear magnetic resonance (utilizing spin states of atoms and molecules).

### 2.7 Entanglement Requirement

As discussed above, in order to effect quantum computing, a physical system containing a collection of qubits is needed. The general state of two qubits, a|00>+b|01>+c|10>+d|11> is a four-dimensional state vector, one dimension for each distinguishable state of the two qubits. When an entanglement operation has been performed between the two qubits, their states are entangled. This means that they generally cannot be written as a product of the states of two individual qubits. The state of n entangled qubits is therefore typically specified by a 2ⁿ-dimensional complex state vector. The creation of 2ⁿ-dimensional complex vectors provides a basis for the computing potential of quantum computers. For more information on qubits and entanglement, see Braunstein and Lo.

Current methods for entangling qubits in order to realize 2ⁿ-dimensional complex state vectors are susceptible to loss of coherence which is the loss of the phases of quantum superpositions in a qubit as a result of interactions with the environment. Loss of coherence results in the loss of the superposition of states in a qubit. See, for example, Zurek, 1991, Physics Today 44, p. 36; Leggett et al., 1987, Reviews of Modern Physics 59, p. 1; Weiss, 1999, Quantitative Dissipative Systems, 2^{nd} ed., World Scientific, Singapore; and Hu et al., arxiv,org: cond-mat/0108339v2, each of which is hereby incorporated by reference in its entirety.

### 2.8 State of the Art

Accordingly, given the above background, there is a need in the art to model molecular systems with greater accuracy and more speed than is currently possible even with the most advanced supercomputers. The algorithms and computational resources currently used are inadequate for tackling these challenges because they involve truncation of full QM equations needed to describe the molecular systems under study. There is also a need in the art for a means to confirm results of calculations for modeling molecular systems on a classical computer.

### 3. SUMMARY OF THE INVENTION

One embodiment provides a method adapted for use on a hybrid computer. The method is for simulating a molecular system. The hybrid computer comprises classical and quantum components. The method provides input to a classical computer. The input comprises atomic coordinates \vec{R}ₙ, atomic charges Zₙ, and one or more parameters for the molecular system. The input is sent to the quantum computer where a ground state energy of the molecular system is determined based on the input nuclear coordinates. This ground state energy is represented by an R-bit binary number. The ground state energy is returned to the classical computer and the nuclear coordinates are geometrically optimized on the classical computer based on information about the ground state energy of corresponding nuclear coordinates to produce new nuclear coordinates \vec{R}′ₙ. These steps are repeated in accordance with a refinement algorithm until the ground state nuclear coordinates of the molecular system have been reached. Then, the one or more parameters specified in the input are returned.

One aspect of the invention provides a method of simulating a molecular system for use on a hybrid system, where the hybrid system comprises a classical computer and a quantum computer. In the method, an input from the classical computer is sent to the quantum computer. This input comprises a set of atomic coordinates \vec{R}ₙ of the molecular system and a set of atomic charges Zₙ for the set of atomic coordinates. The quantum computer is used to determine a ground state energy of the molecular system based on the input set of atomic coordinates. This ground state energy of the molecular system is returned to the classical computer, which uses this information to optimize the set of atomic coordinates thereby producing a new set of atomic coordinates \vec{R}′ₙ for the molecular system. These steps are repeated. In each repetition, the new set of atomic coordinates \vec{R}′ₙ from the last iteration of the method become the set of atomic coordinates \vec{R}ₙ used in the new iteration of the method. The method ends when a predetermined termination condition is reached.

In some embodiments, the ground state energy of the molecular system returned to the classical computer in step (C) is represented by a binary number. In some embodiments, the binary number consists of R bits selected to minimize error in the ground state energy according to the following formula:
E=Eₒ2^{-R}
where E is the error in the calculated ground state energy, and E₀ is an empirical constant.

In some embodiments, the input to the quantum computer further comprises a number specifying a number of electrons N in the molecular system. In some embodiments, the input further comprises a set of one or more parameters of the molecular system (e.g., a set of ground state atomic coordinates of the molecular system and a ground state energy of the molecular system as determined by the quantum computer). In some embodiments, the quantum computer comprises a superconducting quantum processor.

In one aspect of the invention, the method further comprises sending the ground state atomic coordinates from the classical computer to the quantum computer, along with the parameter U of the molecular system for which a quantum calculation is sought; and then causing the quantum computer to solve for U and return the output to the classical computer. In some embodiments, these steps are repeated once for each parameter U in a plurality of parameters U.

In some embodiments, the predetermined termination condition is any combination of: (i) a time when the ground state energy of the molecular system falls below a specified value; (ii) a predetermined number of repetitions of the method; (iii) a time when the ground state atomic coordinates of the molecular system has been reached; (iv) the atomic coordinates of the molecular system for the ground state has been reached within a predetermined accuracy; and (v) the achievement of a predetermined condition of a general optimization algorithm run on the classical computer.

In some embodiments, the input to the quantum computer further comprises a request for the calculation of an unknown value and the output from the quantum computer further comprises a particular value of the unknown value. In some embodiments, the output further comprises an updated value for an additional output parameter for the molecular system.

In some embodiments, molecular system comprises a first molecule and a second molecule and the second molecule is noncovalently bound to the first molecule. In some instance in accordance with such embodiments, the atomic coordinates for the first molecule in the set of atomic coordinates \vec{R}ₙ of the molecular system have been experimentally determined (e.g., by X-ray crystallography, nuclear magnetic resonance, or mass spectrometry). In some instance in accordance with such embodiments, the first molecule is a protein having a molecular weight of 1000 Daltons or greater. In some instances in accordance with such embodiments, the second molecule binds to the first molecule thereby inhibiting an enzymatic activity associated with the first molecule.

Another aspect of the present invention provides a method of determining the ground state energy of a molecular system. In the method an initial electron distribution is determined for a plurality of electrons in the molecular system based on a set of atomic coordinates for the molecular system. In this approach, a nucleus charge of a first nucleus in the set of atomic coordinates is set to a large magnitude such that all of the electrons in the plurality of electrons are localized around the first nucleus. The method continues by assigning each respective electron in the plurality of electrons to a corresponding grid register in a plurality of grid registers. Each respective electron in the plurality of electrons is initialized in its corresponding grid register according to the initial electron distribution. The method continues with the adiabatic reduction in the nuclear charge on the first nucleus in a series of steps until the first nucleus has reached its natural charge value. The reduction is simulated by a sequence of operators applied to qubits in each of the grid registers in the plurality of grid registers. The ground state energy of the molecular system is then computed using the Eigenvalue finding algorithm. Finally, the ground state energy of the molecular system is transferred to a readout register using a measurement algorithm.

In some embodiments, the initializing comprises representing a state of an electron in the plurality of electrons is by a superposition of grid register states for the grid register corresponding to the electron. The plurality of grid registers can be of equal size. In some embodiments, the initializing step includes initializing the readout register in a ground state. In some embodiments, the transferring step further comprises providing the ground state electron distribution energy to the readout register. In some embodiments, the plurality of grid registers and the readout register are comprised of superconducting qubits. In some embodiments, the initializing step causes a grid register in the plurality of grid registers to encode an eigenstate of a corresponding electron in the plurality of electrons. The eigenstate can be a position eigenstate.

Another aspect of the invention provides a computer program product for use in conjunction with a classical computer system. The computer program product comprises a computer readable storage medium and a computer program mechanism embedded therein. The computer program mechanism is for simulating a molecular system and comprises instructions for sending an input from the classical computer system to a quantum computer. This input comprises a set of atomic coordinates \vec{R}ₙ of the molecular system and a set of atomic charges Zₙ for the set of atomic coordinates. The computer program mechanism further comprises instructions for determining, using the quantum computer, a ground state energy of the molecular system based on the input set of atomic coordinates as well as instructions for receiving the ground state energy of the molecular system from the quantum computer. The computer program mechanism further comprises instructions for optimizing the set of atomic coordinates based on information about the ground state energy of the molecular system provided by the instructions for receiving, thereby producing a new set of atomic coordinates \vec{R}′ₙ for the molecular system. The computer program mechanism further comprises instructions for repeating the foregoing instructions, where the new set of atomic coordinates \vec{R}′ₙ, from the last instance of the instructions for optimizing becomes the set of atomic coordinates \vec{R}ₙ used in the repeated instructions for sending, until a predetermined termination condition is reached.

In some embodiments, the ground state energy of the molecular system returned to the classical computer system by the instructions for receiving are represented by a binary number. In some embodiments, the input further comprises a number specifying a number of electrons N in the molecular system.

In some embodiments, the computer program mechanism further comprises instructions for sending the ground state atomic coordinates from the classical computer system to the quantum computer, along with a parameter U of the molecular system for which a quantum calculation is sought as well as instructions for causing the quantum computer to solve for U and return the output to the classical computer system. Such instructions can be repeated once for each parameter U in a plurality of parameters U.

In some embodiments, the predetermined termination condition is any combination of (i) a time when the ground state energy of the molecular system falls below a specified value; (ii) a predetermined number of repetitions of the method; (iii) a time when the ground state atomic coordinates of the molecular system has been reached;

(iv) the atomic coordinates of the molecular system for the ground state has been reached within a predetermined accuracy; and (v) the achievement of a predetermined condition of a general optimization algorithm run on the classical computer.

In some embodiments, the binary number consists of R bits selected to minimize error in the ground state energy according to the formula E=Eₒ2^{-R} where E is the error in the calculated ground state energy, and E₀ is an empirical constant.

Still another aspect of the present invention provides a computer program product for use in conjunction with a classical computer system. The computer program product comprises a computer readable storage medium and a computer program mechanism embedded therein. The computer program mechanism is for determining the ground state energy of a molecular system and comprises instructions for determining an initial electron distribution of a plurality of electrons in the molecular system based on a set of atomic coordinates for the molecular system, where a nucleus charge of a first nucleus in the set of atomic coordinates is set to a large magnitude such that all of the electrons in the plurality of electrons are localized around the first nucleus. The computer program mechanism further includes instructions for assigning each respective electron in the plurality of electrons to a corresponding grid register in a plurality of grid registers. The computer program mechanism further includes instructions for initializing each respective electron in the plurality of electrons in its corresponding grid register according to the initial electron distribution. The computer program mechanism further includes instructions for adiabatically reducing the nuclear charge on the first nucleus in a series of steps until the first nucleus has reached its natural charge value. This reduction is simulated by a sequence of operators applied to qubits in each of the grid registers in the plurality of grid registers. The computer program mechanism further includes instructions for computing the ground state energy of the molecular system using the Eigenvalue finding algorithm and instructions for transferring the ground state energy of the molecular system to a readout register using a measurement algorithm.

Still another embodiment of the present invention provides a method of calculating the energy of a molecular system comprising initializing a plurality of qubits, where the plurality of qubits comprises a set of readout qubits and a set of evolution qubits. Each qubit in the plurality of qubits has a state, the set of readout qubits is initialized in a vacuum state, and the set of evolution qubits is initialized in a predetermined state. In the method, each qubit in the set of readout qubits is rotated by an angle of about π/2 radians around the x-axis and the plurality of qubits is evolved with a unitary operator. A quantum Fourier transform is performed on the set of readout qubits; and the set of readout qubits is measured.

In some embodiments, in the initializing step, the predetermined state of the set of evolution qubits is computed by a step for determining the predetermined state. In some embodiments, the rotating step comprises applying a plurality of \hat{σ}ₓ pulses, each of area π/2, to each of the qubits in the set of readout qubits. In some embodiments, the plurality of pulses are applied in parallel or series. In some embodiments, the initializing step occurs before the rotating. In some embodiments, the rotating step transforms the state of a qubit in the plurality of qubits from a first state:
|0> [symbol] |Ψ_{GS}>
to a second state:

$$\frac{1}{\sqrt{Γ}} {\sum }_{j = 0}^{Γ - 1} \vert j 〉 ⊗ \vert {Ψ}_{GS} 〉 ,$$

where |j> is a state corresponding to a binary value j and F is a natural number.

In some embodiments, the evolving step comprises repeatedly applying a second unitary operator Û to the set of evolution qubits. In some embodiments, the unitary operator is time independent. In some embodiments, the quantum Fourier transform causes interference between states of the qubit in the set of readout qubits. In some embodiments, the readout step includes measuring the state of the set of readout qubits. In some embodiments, the readout step comprises computing an eigenvalue encoded in the state of the readout register, and the eigenvalue corresponds to an eigenvector stored in the set of evolution qubits after the measuring step. In some embodiments, the state of the set of evolution qubits is an eigenvector corresponding to an eigenvalue just measured in the state of the set of readout qubits. In some embodiments, the eigenvalue is a ground state of the molecular system being emulated. In some embodiments, the predetermined state is an approximate ground state of a molecular system being emulated.

Still another aspect of the invention provides a method of calculating an energy of a molecular system. In the method, a plurality of qubits is initialized. The plurality of qubits comprises a set of readout qubits in a first predetermined state and a set of evolution qubits in a second predetermined state. The second predetermined state is computed by adiabatically varying the magnitude of a set of nuclear charges in the molecular system and the second predetermined state is a quantum state of the molecular system. The method continues by computing the energy of the second predetermined state by performing an eigenvalue finding algorithm on the plurality of qubits. In some embodiments, the eigenvalue finding algorithm comprises (i) applying a plurality of \hat{σ}ₓ pulses each of area about π/2 to each of the qubits in the set of readout qubits, (ii) evolving the plurality of qubits with repeated application of a time independent operator, (iii) performing a quantum Fourier transform on the set of readout qubits; and (iv) measuring the state of the set of readout qubits. In some embodiments, the first predetermined state is a vacuum state.

### 4. BRIEF DESCRIPTION OF THE DRAWINGS

FIG. 1 illustrates a black box apparatus in accordance with an embodiment of the present invention.

FIG. 2 illustrates more details of a black box apparatus in accordance with an embodiment of the present invention.

FIG. 3 illustrates a hybrid algorithm for molecular modeling in accordance with an embodiment of the present invention.

FIG. 4 illustrates a hybrid algorithm for molecular modeling in accordance with another embodiment of the present invention.

FIG. 5 illustrates a quantum algorithm for molecular modeling in accordance with still another embodiment of the present invention.

FIG. 6 illustrates a four by four by four grid in which the \hat{x}-direction is horizontal to the page, the ŷ-direction is vertical to the page, the \hat{z}-direction is positioned perpendicularly to the \hat{x}- and ŷ-directions, and the state [111010 011111] is shown explicitly, in accordance with an embodiment of the present invention.

FIG. 7 illustrates a schematic diagram of a computer system for modeling molecular systems in accordance with an embodiment of the present invention.

Like reference numerals refer to corresponding parts throughout the several views of the drawings.

### 5. DETAILED DESCRIPTION

In accordance with the present invention, systems and methods that represent novel approaches to molecular modeling are provided.

5.1 Black Box Technology

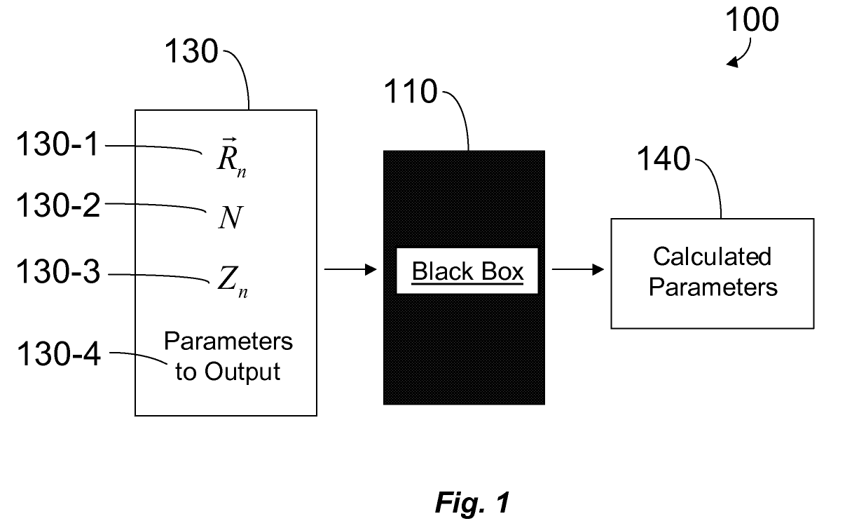

Referring to FIG. 1, one embodiment of the present invention provides a specific-purpose machine 100 that overcomes the exponential scaling of QM by employing a programmable QM system, called a quantum computer, to solve the QM equations for a set of desired parameters (e.g., a molecular system). This strategy reduces the physical resources required to solve the full QM equations from an exponential function of the number of electrons to a polynomial function of the number of electrons. Solving the full QM equations using the architecture of the present invention leads to significant increases in the sizes of systems that can be simulated, the accuracy of the solutions obtained, and the speed of calculation.

In an embodiment of the present invention, the inputs to machine 100 are aspects of a molecular system or systems such as:
(1) an initial “best guess” of the atomic coordinates and charges;
(2) optionally, the number of electrons to be modeled; and
(3) physical parameters of the system requested as output (e.g., ground states and/or ground state energies, ground state or near-ground state atomic coordinates, estimates of the potential energy required to adopt such ground or near-ground states, binding energies between receptor/ligand pairs, or best guess estimates of any of the foregoing, etc.).

Machine 100 acts to return all requested parameters, which can include, for example, the ground state nuclear positions, ground state or excited energies, charge density distributions, correlation functions, momentum distributions, and polarization.

FIG. 1 illustrates a black box schematic of machine 100 in an embodiment of the present invention. Inputs 130 comprise an initial atomic configuration 130-1, represented as \vec{R}ₙ¹, for the molecular system to be used for the calculation; the number of electrons 130-2, represented as N; the number of nuclear charges, represented as Zₙ; and a specification of which parameters to output 130-4. In some embodiments of the invention, the initial atomic configuration 130-1 specifies the location of each atom in the system in Cartesian coordinates. Typically, three dimensions are used to specify the atomic coordinates. Although not explicitly illustrated in FIG. 1, input 130 can comprise the coordinates of more than one molecular entity. For example input 130 can comprise the atomic coordinates of a receptor (e.g., a protein) and a ligand that potentially binds to the receptor. Proteins are described in Stryer, Biochemistry, W.H. Freeman and Company, New York, 1988, Chapter 2, which is hereby incorporated by reference in its entirety. As noted in Stryer, some proteins have enzymatic activity.

Machine or black box 110 calculates the ground state atomic configuration of the input molecular system 130 and returns the output 140. The details of this calculation are described below. Output 140 comprises the calculated parameters as specified by a user (130-4). In some embodiments of the present invention, output parameters 140 comprise the ground state atomic coordinates and/or the ground state energy of the molecular system under study. In some embodiments, any observable of the molecular system can be specified in parameters to output 130-4 and provided as result of the computation in output 140. In some embodiments, a molecular system is any molecular entity. In some embodiments, a molecular system is one or more organic compounds, where at least one of the organic compounds in the molecular system has a molecular weight of more than 100 Daltons, more than 200 Daltons, more than 300 Daltons, more than 400 Daltons, more than 1000 Daltons, between 1000 Daltons and 5000 Daltons, or between 2000 Daltons and 100,000 Daltons. One Dalton equals 1 atomic mass unit (a.m.u.) or 1.66×10⁻²⁷ kilograms, atomic mass units and Daltons may be used interchangeably herein. In instances where there is more than one compound in the molecular system, the two or more compounds are typically bound to each other by molecular interactions that are typically not covalent (e.g., electrostatic interactions). As such the systems and methods of the present invention can be used to calculate a binding energy between a receptor and a ligand. Generally, such ligands are any type of organic compound, such as organic compounds having one or more functional groups described in Streitwieser and Heathcock, Introduction to Organic Chemistry, 1981, Macmillan Publishing Company, New York, which is hereby incorporated by reference in its entirety.

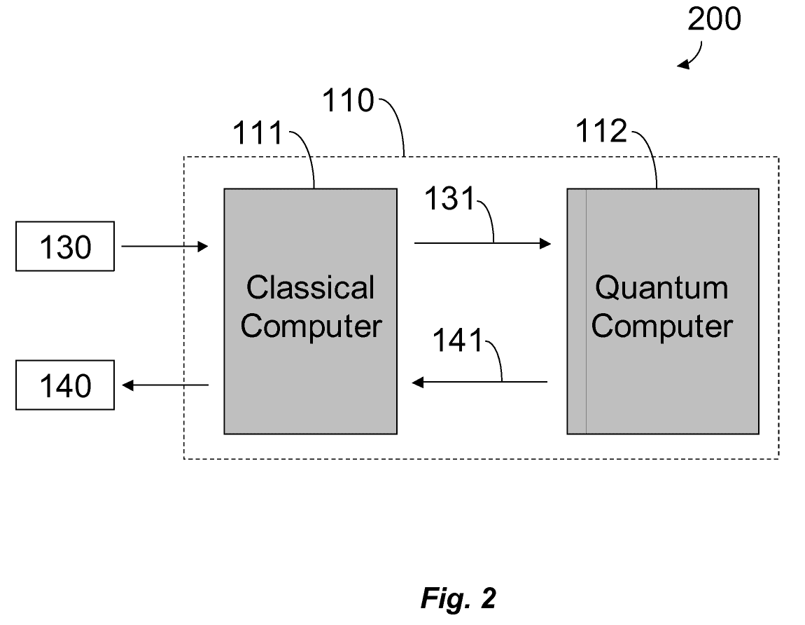

Black box 110 comprises a hybrid computer architecture that combines a classical computer with one or more quantum processors. FIG. 2 illustrates a schematic 200 of the main components of black box 110 in one embodiment of the present invention. Classical computer 111 functions as a manager of the computational resources of the quantum processors. Classical computer 111 accepts inputs 130 from a user or other entity and returns output 140. It will store information about the molecular system and use the quantum processors to advantageously determine desired parameters for any configuration of a molecular system as specified in quantum computer input 131. In some cases, classical computer 111 is a supercomputer capable of processing large amounts of data. Exemplary supercomputers include, but are not limited to, the Cray SX-6, X1, and XD1 (Cray Inc., Seattle Wash.) and the Hitachi SR11000 (Tokyo, Japan). Classical computer 111 interfaces with the quantum computer 112 via quantum computer input 131 and quantum computer output 141. In accordance with the present invention, interfaces 131 and 141 permit certain aspects of the calculation to be performed on quantum computer 112.

In one embodiment of the present invention the interfaces 131 and 141 operate as digital to analog converters, and analog to digital converters. However, these interfaces 131 and 141 are designed to minimize their effect on the quantum computer. Because quantum computers need to be isolated from their environment, interfaces 131 and 141 have appropriate shielding and filtering to isolate the quantum computer 112 from noise and other effects. In one embodiment of the present invention, interfaces 131 and 141 operate as serial or as parallel communication channels. In embodiments of the present invention where quantum computer 112 operates at low temperature, interfaces 131 and 141 can be embodied in a series of devices existing at low temperature and the temperature of the classical computer 111, and temperatures between. In embodiments of the present invention, interfaces 131 and 141 are means for transferring information from classical computer 111 to quantum computer 112 or the reverse. Interfaces 131 and 141 can be composed of semiconductor circuits, superconductor circuits, optical devices and channels, digital circuits, and analog circuits. The embodiments of interfaces 131 and 141 vary with the embodiments of classical computer 111 and quantum computer 112. Examples of control systems include, but are not limited to, U.S. Pat. No. 6,803,599, entitled “Quantum processing system for a superconducting phase qubit,” issued Oct. 12, 2004, U.S. Pat. No. 6,897,468, entitled “Resonant controlled qubit system,” issued May 24, 2005; WIPO Patent Publication Number W004086295A1, entitled “A control architecture for a quantum computer,” published Oct. 7, 2004; U.S. Pat. No. 6,597,010, entitled “Solid-state quantum dot devices and quantum computing using nanostructured logic gates,” issued Jul. 22, 2003; and WIPO Patent Publication Number WO9859255A1, entitled “A method for suppressing noise in measurements,” published Dec. 30, 1998, each of which is hereby incorporated by reference in its entirety.

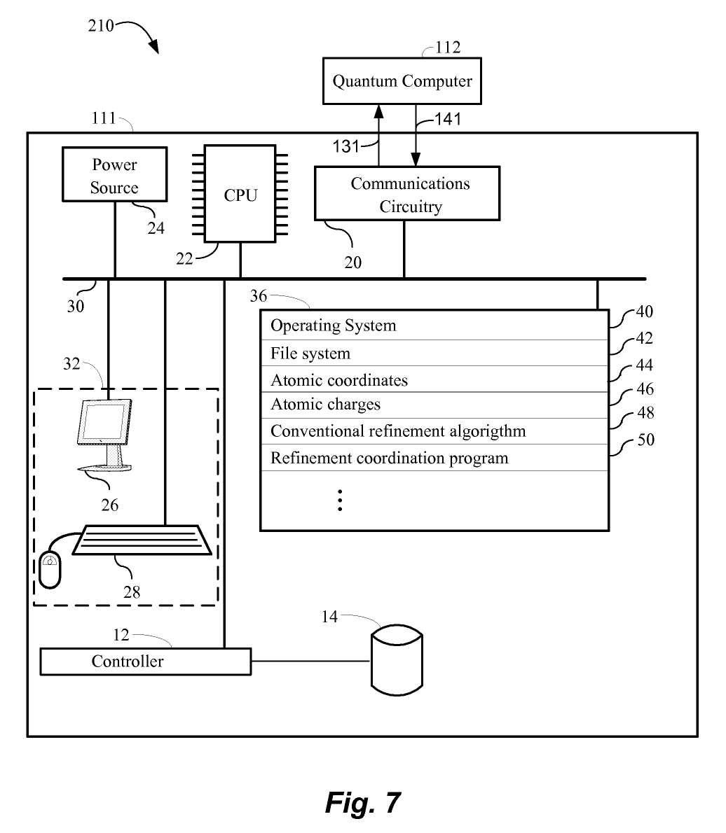

FIG. 7 illustrates more details of a system 210 for molecular modeling in accordance with one embodiment of the present invention. The system 210 depicted in FIG. 7 can be used to perform any of the algorithms and methods disclosed herein. Classical computer 111 functions as a manager of the computational resources of the quantum processors. Classical computer 111 accepts inputs from a user or other entity and returns output. Classical computer 111 is preferably a computer system having:
a central processing unit 22;
a main non-volatile storage unit 14, for example, a hard disk drive, for storing software and data, the storage unit 14 controlled by controller 12;
a system memory 36, preferably high speed random-access memory (RAM), for storing system control programs, data, and application programs, comprising programs and data loaded from non-volatile storage unit 14; system memory 36 may also include read-only memory (ROM);
a user interface 32, comprising one or more input devices (e.g., keyboard 28) and a display 26 or other output device;
communication circuitry 20 described herein for interfacing with quantum computer 112;
an internal bus 30 for interconnecting the aforementioned elements of the system; and
a power source 24 to power the aforementioned elements.

Operation of computer 111 is controlled primarily by operating system 40, which is executed by central processing unit 22. Operating system 40 can be stored in system memory 36. In addition to operating system 40, in a typical implementation system memory 36 includes:
file system 42 for controlling access to the various files and data structures used by the present invention;
atomic coordinates 44 of a molecular system to be modeled;
atomic charges 46 of the atoms in the atomic coordinates;
a conventional refinement algorithm 48 for refining the atomic coordinates of the molecular system; and
a refinement coordination program 50 for interfacing with quantum computer 112.

An embodiment of the present invention provides a computer program product for use in conjunction with a classical computer system 111. The computer program product comprises a computer readable storage medium (e.g., memory 36, a DVD, a computer media tape, or other device) and a computer program mechanism embedded therein (e.g., refinement coordination program 50). In one embodiment, the computer program mechanism is refinement coordination program 50. In this embodiment, refinement coordination program 50 comprises instructions for sending an input from classical computer system 111 to a quantum computer 112. The input comprises a set of atomic coordinates \vec{R}ₙ 44 of the molecular system and a set of atomic charges Zₙ 46 for the set of atomic coordinates 44. The refinement coordination program 50 further comprises instructions for determining, using the quantum computer 112, a ground state energy of the molecular system based on the input set of atomic coordinates 44. The refinement coordination program 50 further comprises instructions for receiving the ground state energy of the molecular system from the quantum computer. The refinement coordination program 50 further comprises instructions for optimizing the set of atomic coordinates based on information about the ground state energy of the molecular system provided by the instructions for receiving, thereby producing a new set of atomic coordinates \vec{R}′ₙ, optionally stored as atomic coordinates 44, for the molecular system. The refinement coordination program 50 further comprises instructions for repeating the foregoing instructions, where the new set of atomic coordinates \vec{R}′ₙ from the last instance of the instructions for optimizing become the set of atomic coordinates \vec{R}ₙ used in the repeated instructions for sending, until a predetermined termination condition is reached.

Another embodiment of the present invention provides a computer program product for use in conjunction with a classical computer system 111. The computer program product comprises a computer readable storage medium (e.g., memory 36, a DVD, a computer media tape, or other device) and a computer program mechanism embedded therein (e.g., refinement coordination program 50) for determining the ground state energy of a molecular system. In one embodiment, the computer program mechanism is a refinement coordination program 50. In this embodiment, refinement coordination program 50 comprises instructions for determining an initial electron distribution of a plurality of electrons in the molecular system based on a set of atomic coordinates for the molecular system where a nucleus charge of a first nucleus in the set of atomic coordinates is set to a large magnitude such that all of the electrons in the plurality of electrons are localized around the first nucleus. Refinement coordination program 50 further comprises instructions for assigning each respective electron in the plurality of electrons to a corresponding grid register in a plurality of grid registers. Refinement coordination program 50 further comprises instructions for initializing each respective electron in the plurality of electrons in its corresponding grid register according to the initial electron distribution. Refinement coordination program 50 further comprises instructions for adiabatically reducing the nuclear charge on the first nucleus in a series of steps until the first nucleus has reached its natural charge value, where the reduction is simulated by a sequence of operators applied to qubits in each of the grid registers in the plurality of grid registers. Refinement coordination program 50 further comprises instructions for computing the ground state energy of the molecular system using the Eigenvalue finding algorithm. Refinement coordination program 50 further comprises instructions for transferring the ground state energy of the molecular system to a readout register using a measurement algorithm.

In one aspect of the invention machine 110 iterates through different molecular configurations to find a particular molecular configuration of the molecular system under study that minimizes the ground state energy of the molecular system. Once machine 110 has determined the coordinates of the molecular system leading to this lowest ground state energy, it returns the coordinates along with the corresponding output parameters 140. In some embodiments, rather than finding the minimum ground state energy of the molecular system machine 110 iterates through successive molecular configurations of the molecular system until a molecular configuration having less than a specified energy is identified.

In one application of the present invention, the binding affinity between a small molecule and a macromolecular receptor binding site is calculated. In some embodiments, the hybrid computer architecture can model the optimal binding configurations between a small molecule and a macromolecular receptor and minimize their corresponding intermolecular binding energies. In this manner, the black-box technology fits into existing schemes for computational drug discovery and development while providing increases in computational speed and accuracy that cannot be achieved with classical computers.

In some embodiments of the present invention, the specific details of the classical computer 111 and quantum computing 112 aspects of the hybrid computer architecture are flexible as long as pertinent information is exchanged between the classical computer and the quantum computer. For example, the algorithm run on the quantum processor can vary depending on the power and capacity of the quantum processor being used. In some embodiments, the quantum processor is one or more superconducting quantum computing chips. However, different functional quantum processors can be used for performing these tasks.

### 5.2 Hybrid Algorithm

In accordance with the present invention, a hybrid algorithm is provided that takes as input an approximation of the atomic coordinates of a molecular system and finds the ground state atomic coordinates, or ‘natural’ coordinates of the system and returns these new coordinates along with a quantity or set of observables for that state, such as the ground state energy. The hybrid algorithm specifies the manner of function of the machine described in FIG. 1 and FIG. 2, and uses a novel architecture that combines classical and quantum computing resources.

The hybrid algorithm works by solving Schrödinger's equation given a coordinate set. In conventional modeling applications, the interaction between objects in a molecular system is described either by a force field, a quantum chemical model, or a mix between the two. As noted in Section 2.2, in the context of molecular dynamics, a force field, also called a forcefield, is a loosely defined term and refers to the functional form and parameter sets used to describe the interactions (potential, forces) within a system of particles (atoms, ions, or similarly sized objects) as well as the interaction with electrons, or similarly charged leptons. It is independent of the system's configuration and is not a numerical field as in the above context. A force field can be empirical, derived from higher-level modeling (e.g. quantum chemical studies), or even heuristic. Popular software packages for molecular dynamic simulation of biological molecules include: AMBER (Assisted Model Building and Energy Refinement), CHARMM (Chemistry at HARvard Molecular Mechanics), GROMACS (Groningen Machine for Chemical Simulations), GROMOS, and NAMD. Computation of the total energy of a molecule using a force field or a quantum chemical model is a computationally expensive task for a classical computer. For this reason, many force fields and quantum chemical models simply approximate the energetic interactions that arise between particles (e.g., atoms) in a molecular system, thus trading off the time to complete the solution with the accuracy of the solution. The present invention is advantageous because this computationally expensive task is removed from the global optimization scheme. That is, computation of the total energy of a molecular system is not performed on a digital (classical computer). Rather, all or a portion of such a computation is performed on a quantum computer in the present invention. Furthermore, because the computation of the ground state energy of the molecular system is computed on a quantum computer, the full Schrödinger equation for the molecular system can be solved rather than a force field or quantum chemical model that merely approximates the full Schrödinger equation representing the molecular system. The present invention thus provides an advantageous feature in which a molecular system is refined on a digital computer using known geometric restraints of the molecular system and, at intervals specified by known global optimization algorithms, the ground state energy of the molecular system is updated in order to identify candidate structures that represent the naturally occurring state of the molecular system.

The software packages for molecular dynamic simulation of biological molecules cited in the preceding paragraphs are further described in the following references. For AMBER see Pearlman, et al., 1995, “AMBER, a computer program for applying molecular mechanics, normal mode analysis, molecular dynamics and free energy calculations to elucidate the structures and energies of molecules,” Computer Physics Communications 91, pp. 1-41. For CHARMM, see Brooks et al., 1983, “CHARMM: A Program for Macromolecular Energy, Minimization, and Dynamics Calculations,” Journal of Computational Chemistry 4, pp. 187-217. For GROMACS, see Berendsen et al., 1995, “GROMACS: A message-passing parallel molecular dynamics implementation,” Computer Physics Communications 91, pp. 43-56. For GROMOS, see Van Gunsteren and Berendsen, 1990, “Computer Simulation of Molecular Dynamics Methodology, Applications and Perspectives in Chemistry,” Angewandte Chemie International Edition 29, pp. 992-1023; and Van Gunsteren et al., 1995, “Computer simulation of protein motion,” Computer Physics Communications 91, pp. 305-319. And finally, for NAMD, see Kalé et al., 1999, “NAMD2: Greater scalability for parallel molecular dynamics,” Journal of Computational Physics 151, pp. 283-312; and Brunner et al., 2000, “Scalable Molecular Dynamics for Large Biomolecular Systems,” Proceedings of the IEEE/ACM SC2000 Conference, IEEE Press. Each of the immediately preceding references is hereby incorporated by reference in its entirety. Additional references to known algorithms are disclosed in Section 2.2 and hereby incorporated by reference.

The software packages for molecular dynamic simulation of biological molecules cited above are commercially available. For example, AMBER is available from the Department of Pharmaceutical Chemistry, University of California, San Francisco, Box 2280, 600 16^{th} Street, San Francisco, Calif. 94143-2280. CHARMM is available from the CHARMM Development Project, Department of Chemistry and Chemical Biology, 12 Oxford Street, Harvard University, Cambridge, Mass. 02138. GROMACS is available online at http://www.gromacs.org/. GROMOS is available from BIOMOS b.v, Laboratory of Physical Chemistry, ETH Hönggerberg, HCI, CH-8093 Züirich, Switzerland. NAMD is available from the Beckman Institute for Advanced Science and Technology at the University of Illinois at Urbana-Champaign, 405 North Mathews Avenue, Urbana, Ill. 61801.

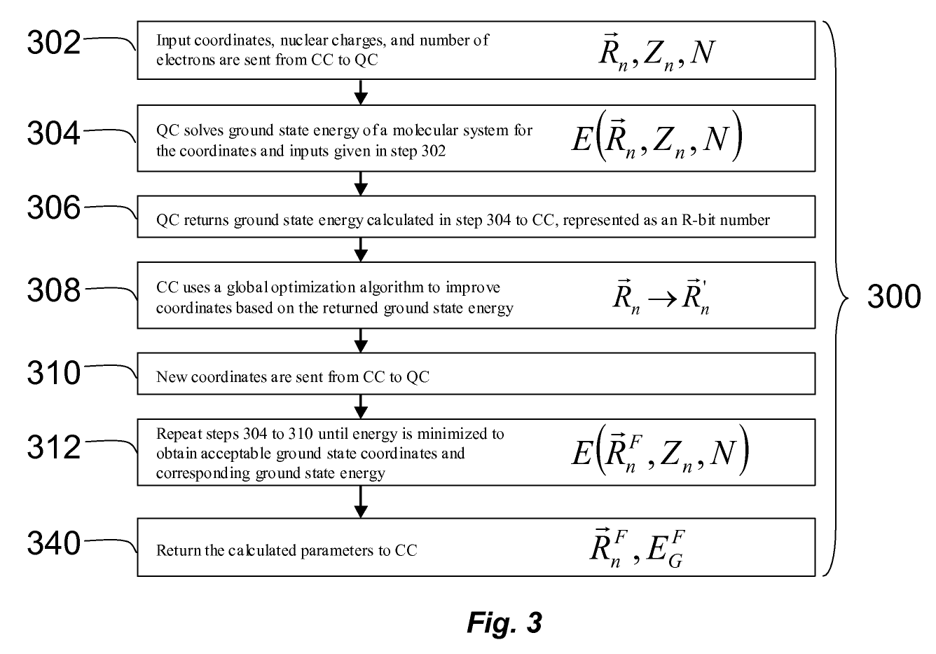

In accordance with one embodiment of the present invention, a hybrid algorithm 300 for determining the ground state coordinates, or naturally occurring coordinates of a molecule, comprises the steps detailed in FIG. 3:

step 302: nuclear coordinates \vec{R}ₙ, nuclear charges Zₙ and, optionally, the number of electrons N in a molecular system of interest are sent from a classical computer (CC) to a quantum computer (QC);

step 304: quantum computer 112 solves for the ground state energy E(\vec{R}ₙ, Zₙ, N) of the molecular system of interest as an R-bit binary number, where R is the number of qubits in a read out register in the quantum computer (optionally using the Born-Oppenheimer approximation);

step 306: quantum computer sends the R-bit number E(\vec{R}ₙ,Zₙ, N) to the CC;

step 308: the classical computer uses a global optimization algorithm to update \vec{R}ₙ →\vec{R}′ₙ based on E(\vec{R}ₙ, Zₙ, N);

step 310: new coordinates \vec{R}′ₙ are sent from the classical computer to the quantum computer;

step 312: steps 302 through 310 are repeated until the energy E of the molecular system is either minimized or until the difference between the energy E(\vec{R}ₙ, Zₙ, N) and the energy of new coordinates E(\vec{R}′ₙ,Zₙ, N) is less than a threshold value in order to obtain ground state coordinates \vec{R}ₙ^{F} and the corresponding ground state energy E(\vec{R}ₙ^{F}, Zₙ, N); and

step 340: calculated parameters comprising the final ground state coordinates \vec{R}ₙ^{F} and the corresponding ground state energy E(\vec{R}^{F}ₙ, Zₙ, N) are returned to a user.

The hybrid algorithm 300 is described in further detail below.

Step 302. The hybrid algorithm starts by accepting as input an estimate of the nuclear coordinates (coordinates) \vec{R}ₙ for each atom in the molecular system, along with the nuclear charges Zₙ and, optionally, the number of electrons, N. The subscript n is an integer that identifies an atom and goes from 1 to Z, where Z is the number of atoms in the molecular system. In some embodiments, this estimate for the initial nuclear coordinates is determined based on well known algorithms such as Hartree-Fock, for example. The essence of the Hartree-Fock approximation is to replace the complicated many-electron problem by a one-electron problem in which electron-electron repulsion is treated in an average way. See, for example, Szabo and Ostlund, 1989, Modern Quantum Chemistry: Introduction to Advanced Electronic Structure Theory, Dover, Mineola, N.Y.; and Fischer, 1977, The Hartree-Fock Method for Atoms: A Numerical Approach, John Wiley & Sons, each of which is hereby incorporated by reference in its entirety. Algorithms for estimating the nuclear coordinates of a molecular system can be performed efficiently but have limited accuracy. In accordance with the present invention, the role of the hybrid algorithm is to increase this accuracy in order to accurately simulate the molecular systems.

In some embodiments, the molecular system for which the naturally occurring three-dimensional coordinates are sought includes more than 10 electrons, more than 20 electrons, more than 30 electrons, more then 40 electrons, more than 50 electrons, more than 100 electrons, more than 500 electrons, more than 1000 electrons, more than 10,000 electrons, or between 10 and 15,000 electrons. In some embodiments, the molecular system is a protein, polypeptide, DNA, RNA, a polymer, or an organic molecule having a molecular weight that is less than 1000 Daltons.

In some embodiments information comprising the estimate of the nuclear coordinates (coordinates) \vec{R}ₙ for each atom in the molecular system, along with the nuclear charges Zₙ and, optionally, the number of electrons, N are transferred from the classical computer to the quantum computer using a communication channel.

In some embodiments, the number of electrons N in a molecular system of interest is inferred from nuclear coordinates \vec{R}ₙ. In some embodiments, the molecular system comprises two or more molecules that are noncovalently bound to each other. In some embodiments, the molecular system comprises a single molecule. In some embodiments, the molecular system has a molecular mass of greater than 100 Daltons, greater than 200 Daltons, greater than 300 Daltons, or greater than 1000 Daltons. In some embodiments, the coordinates for at least a portion of the molecular system that is sent in step 302 are derived from high resolution X-ray crystal structure, mass spectrometry, or nuclear magnetic resonance. For example, in some embodiments, the molecular system comprises a receptor having coordinates determined by X-ray crystallography as well as the coordinates of a ligand, not determined by X-ray crystallography, that have been docked onto the receptor using a conventional modeling program run on a digital computer. Here, the term receptor refers to any type of protein that has an active site (e.g., kinases, phosphodiesterases, metalloproteases, and the like).

Step 304. In step 304, the corresponding energy E(\vec{R}ₙ,Zₙ, N) of the estimated coordinates passed from CC to QC is calculated by the quantum processor by performing a quantum algorithm (see e.g., Section 5.3, Quantum Algorithm). This aspect of the hybrid algorithm is advantageous because the quantum algorithm has substantially reduced complexity over any classical algorithm. The use of the quantum processor permits the machine to obtain results that are otherwise not possible using classical resources (which includes both memory and time resources). As used here, the term quantum algorithm refers to an algorithm that computes the energy of the molecular system using the full form of Schrödinger's equation or, optionally, using the Born-Oppenheimer approximation. In some embodiments of the present invention a quantum algorithm is an algorithm that models quantum behavior of a quantum system without incurring an exponential cost in time or space resources.

Step 306. The energy associated with the ground state E(\vec{R}ₙ, Zₙ, N) of the input coordinates \vec{R}ₙ (coordinates of the molecular system of interest) is returned to the classical computer and becomes a comparison point for the next iteration of the calculation.

Step 308. The coordinates of the system are modified by the CC using a global optimization algorithm, a subset of a global optimization algorithm, or a refinement algorithm that can be implemented in a number of ways. In general, such refinement algorithms refine the potential energy of the molecular system (from instances of step 306) subject to known geometric restraints associated with the molecular system. Typical geometric restraints include acceptable bond lengths and bond angles between each of the nuclei in the molecular system as well as acceptable torsion angles. For each result of step 308, the global optimization algorithm produces a new set of coordinates and sends them to the quantum processor in step 310, which then calculates and returns the ground state energy for comparison.

In some instances, step 308 is a refinement of the coordinates of the molecular system subject to known geometric restraints. In such embodiments, step 308 ends when the root mean square difference between the coordinate set of step 302 and the refined coordinate set of step 308 is less than some threshold value such as 0.01 Angstroms, 0.05 Angstroms, 0.1 Angstroms, 0.2 Angstroms, or greater than 0.3 Angstroms.

Step 310. In step 310, the modified nuclear coordinates \vec{R}′ₙ are passed back to the quantum computer and the algorithm iterates. In some embodiments, the global optimization algorithm takes further advantage of one or more quantum processors by stepping the system coordinates forward a number of iterations for each degree of freedom of the molecular system, where each respective step uses the quantum processor to determine the energy state of the molecular system at the respective step. For each degree of freedom each step yields a difference in energy, and after a number of steps the configuration has rendered enough information for the global optimization algorithm to process and optimize the appropriate path. When more than one quantum processor is used, the algorithm can be parallelized across quantum processors to further increase efficiency. In this manner, the global optimization algorithm rapidly traces a path toward the lowest energy configuration of the molecular system.

Step 312. In step 306, each subsequent iteration of the calculation will determine the energy for a different atomic configuration and each energy will be compared until a terminal point in the algorithm is realized. In one embodiment a terminal point in the algorithm is realized when the ground state configuration of the molecular system has been achieved with a high probability. The algorithm iterates until the ground state energy is minimized, subject to any other termination criteria of the global optimization algorithm. See, e.g., Press et al., 1992, Numerical Recipes in C: the Art of Scientific Computing, 2^{nd} Ed., Cambridge University Press, ISBN 0521431085, which is incorporated herein by reference in its entirety. In some embodiments, a terminal point in the algorithm is realized when the threshold energy level of the molecular system falls below a specified value. In still other embodiments, a terminal point in the algorithm is realized when steps 302 through 310 have been repeated a predetermined number of times (e.g., once, twice, three times, four times, between five and 1000 times, between 1000 and 10,000 times, or more than 10,000 times). In some embodiments, steps 302 through 310 are not repeated.

In some embodiments, a number of quantum co-processors can be used in parallel to accelerate the iteration process. In typical embodiments, steps 302 through 310 are repeated in accordance with the global optimization algorithm. Such embodiments can reject a structure from an instance of step 308 if the energy of the new structure obtained in step 308 is higher than the energy of the structure from the previous instance of step 308. The manner in which steps 302 through 310 are repeated is in accordance with a global optimization algorithm refinement schedule. Such refinement schedules can perturb the state of the molecular system in order to identify a global minimum. For example, in some embodiments, steps 302 through 310 represent one step in a simulated annealing schedule in which the molecular system is set at a given temperature and the structure to be sent to the quantum computer at step 310 is accepted with some probability that is a function of (i) the energy of the coordinates at step 310 versus the energy of the coordinates prior to step 308, and (ii) the current temperature in the annealing schedule. Each successive repetition or set of repetitions of steps 302 through 310 then represents the molecular structure at successively cooler temperatures until the system reaches a global minimum. In this way, the refinement algorithm is given sufficient flexibility to force the molecular system to jump out of local minimum traps in order to identify a global minimum energy and corresponding three-dimensional coordinates for the molecular system. For more information on simulated annealing, see Kirkpatrick, 1983, Science 220, pp. 671-680, which is hereby incorporated by reference in its entirety.

Similarly, steps 302 through 312 can represent a genetic algorithm in which randomized changes in the coordinates of the molecular system are introduced at step 308 and such structures are accepted or rejected at step 312 with some probability in accordance with the genetic algorithm. Alternatively, steps 302 through 312 can represent a least squares minimization, a Bayesian decision theory approach, a maximum-likelihood approach, a linear discriminate function, a neural network, algorithm-independent machine learning, or another refinement algorithm. See, for example, Duda, Pattern Classification, Second Edition, 2001, John Wiley & Sons, Inc., New York and Pearl, Probabilistic Reasoning In Intelligent Systems: Networks of Plausible Inference, Morgan Kauffmann Publishers, Inc., San Francisco, each of which is hereby incorporated by reference in its entirety.

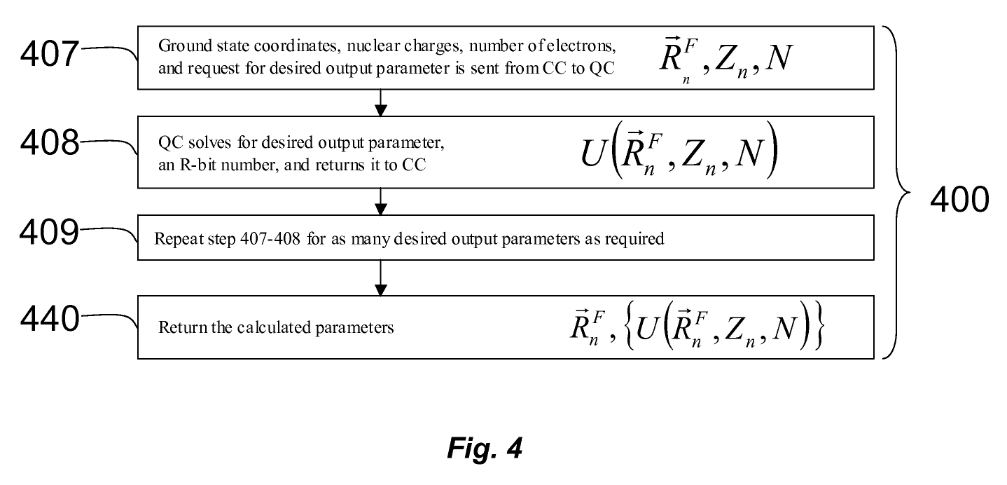

Step 340. Once the natural ground-state configuration \vec{R}ₙ^{F} is identified, other parameters of the molecular system are calculated by the quantum processor, and the output, which comprises the ground state coordinates along with system observables as specified in the input is transferred from the quantum computer to the classical computer. In some cases, the output coordinates and the corresponding energy of the system can be returned as soon as the answer has been calculated, and the algorithm will then continue to calculate the other desired observables U of the system. Examples of U include the time evolution operator in of any local Hamiltonian. See, for example, Lloyd, 1996, Science 273, pp. 1073-1078, which is incorporated herein by reference in its entirety. Further examples of U include charge density distributions, correlation functions, momentum distributions, and the like. FIG. 4 illustrates steps 407 through 409 for how QC computes parameters of interest in accordance with step 340 of FIG. 3:

step 407: send the coordinates \vec{R}ₙ^{F} from the classical computer to the quantum computer, along with a request for the output parameter to calculate U(\vec{R}ₙ^{F},Zₙ,N);

step 408: quantum computer solves for U(\vec{R}ₙ^{F},Zₙ,N) and returns it to CC; and

step 409: repeat steps 407 and 408 for as many desired output parameters as are requested.

The calculated parameters are then returned as output of the calculation in step 440. In some embodiments, each parameter to be calculated is returned as output in 440 once each iteration is complete.

The hybrid algorithm is illustrated by way of example for a hydrogen molecule (H₂) in Section 5.5. In some cases, unless otherwise specified, the quantum processor will calculate the ground state energy for the given coordinates.

Variations of the above-described hybrid algorithm can be realized depending on the computational capability of the quantum processor and the nature of the problem to be solved. In some embodiments, if the target molecular system is too large for complete modeling with the quantum processor, then quantum effects of the system can be localized and the molecular system can be broken into components and modeled separately, a method known as domain decomposition. Such methods are well known and characterized in the field. See, e.g., Yang, 1991, Physical Review Letters. 66, p. 1438, which is hereby incorporated by reference in its entirety. The classical computer transfers each of these components separately to the quantum processor (or processors) and then combines the resulting energies to form an estimate of the energy of that configuration. The usefulness of such an approximation depends on the nature of the system.

In some embodiments, the quantum mechanical aspects of the molecular system can be simplified, in order to make larger problems tractable for the quantum processor. Such simplifications can include, for example, freezing out the core electrons and treating only the valence electrons of each atom. Whether such approximations are useful depends on the nature of the problem being solved.

### 5.3 Quantum Algorithm

An overview of the methods of the present invention have been presented. What follows is a more detailed description of a quantum computing algorithm for determining a ground state of a molecular system in accordance with an aspect of the present invention. This more detailed algorithm is one implementation of FIG. 3, in accordance with an aspect of the present invention. The invention is by no means limited to such an algorithm. Many other examples of suitable quantum computing algorithms and their application, including receptor/ligand docking, have been described in above.

### 5.3.1 Complexity

In accordance with an aspect of the present invention, a quantum algorithm is described herein that combines a method for efficiently determining the ground state of a molecular system with a measurement algorithm described by Abrams and Lloyd for extracting the value of an observable from that ground state. See, for example, Abrams and Lloyd, 1999, Physical Review Letters 83, pp. 5162-5165, which is hereby incorporated by reference in its entirety, for a description of the measurement algorithm. In some embodiments of the present invention, the quantum processor component of the quantum computer comprises a quantum register with a specified number of available quantum bits, or qubits, to perform the operations. The quantum register is divided into one or more grid registers and a readout register, where each register is interconnected via quantum information channels.

In some embodiments, the grid registers define and encode a set of eigenstates. This set is used to define the molecular system's wavefunction as an expansion over these eigenstates. In some embodiments, a grid register encodes electronic position eigenstates. It is shown that this algorithm scales, at most, linearly in the number of electrons, and that the execution time is also linear in the number of electrons.

In some embodiments of the quantum algorithm, each electron in the system is assigned a separate grid register. The number of qubits required can then be defined as NDQ+R, where N is the number of electrons in the system, D is the number of dimensions to be used for the computation, Q is the number of qubits used to define the grid size (giving a total of 2^{Q} grid points per dimension), and R is the number of qubits in the readout register. The readout register is used to store the output of the computation. In most cases the number of dimensions D will be three, and the grid resolution will depend on the type of molecular system to be modeled. Without taking into account qubit encoding and error correction, which is linear in the number of qubits, the NDQ+R number of qubits represents an upper limit for solving these problems. Table 1 provides a list of exemplary molecules with approximate scaling features for the example of the quantum algorithm that uses separate grid registers for each electron in the system. Table 1 illustrates that the maximum number of qubits required scales linearly in the number of electrons in the system. Table 1 is viewed as a nonlimiting and exemplary values for the conditions and assumptions given herein.

TABLE 1
List of exemplary molecules with approximate scaling features needed

| | | | | | Size of | |
|---|---|---|---|---|---|---|
| | | Number of | Number of | Number of | Readout | Max Qubits |
| Molecule | | Electrons | Dimensions | Grid-Qubits* | Register | Required |
| | Formula | N | D | Q | R | NDQ + R |
| Single hydrogen atom | H | 1 | 1 | 4 | 4 | 8 |
| Hydrogen molecule | H₂ | 2 | 3 | 3 | 7 | 25 |
| Water | H₂O | 10 | 3 | 5 | 32 | 182 |
| Glycine | C₂H₅NO₂ | 40 | 3 | 10 | 64 | 1,264 |
| Caffeine | C₈H₁₀N₄O₂ | 102 | 3 | 10 | 64 | 3,124 |
| Protein-ligand docking site | — | 1,000 | 3 | 10 | 128 | 30,128 |

*Actual grid size is defined as 2^{N} for each dimension, where N is the number of qubits.

### 5.3.2 Method

In accordance with an aspect of the present invention, the quantum algorithm takes as inputs the nuclear configuration for the molecular system, and then calculates and returns the ground state energy for that configuration. In some embodiments of the invention, the quantum algorithm simulates an adiabatic transition in the molecule, in which all the electrons are initially highly localized around a nucleus by artificially setting the nuclear charge of the nucleus to a large magnitude (large enough to localize all of the electrons in the system around the one nucleus). Without loss of generality, this nucleus is chosen to be nucleus 1 at position \vec{R}₁ with nuclear charge Z₁, and the nuclear charge is then artificially set to value Z₁¹ that is large enough to localize all of the electrons in the system around nucleus 1. The electronic distribution for such a system of many electrons and one nucleus can easily be calculated using a conventional method such as Hartree-Fock on a conventional computer. This pre-processing results in an electron distribution that is then initialized in the grid registers.

The quantum algorithm then models a process of slowly reducing the artificial nuclear charge for nucleus 1, and increasing the nuclear charge of the other nuclei, such that the electrons slowly become delocalized and are influenced more and more by other nuclei and electrons. The nuclear charge on nucleus 1 is reduced until the nucleus has reached the natural value of Z₁ atomic units of charge. Then, as long as the artificial nuclear charge was decreased at a slow enough rate (e.g., adiabatic limit), the electrons will remain in the ground state energy for the entire system and that energy can be measured and placed in the readout register.

In accordance with the present invention, the quantum algorithm simulates this process of varying the nuclear charge. In some embodiments, changes in the nuclear charge are discretized and each step is converted into a sequence of quantum gates. The quantum processor then simulates the evolution of the actual molecular system and yields the required ground state energy. Section 5.5 includes a detailed description of this algorithm for the hydrogen molecule (H₂).

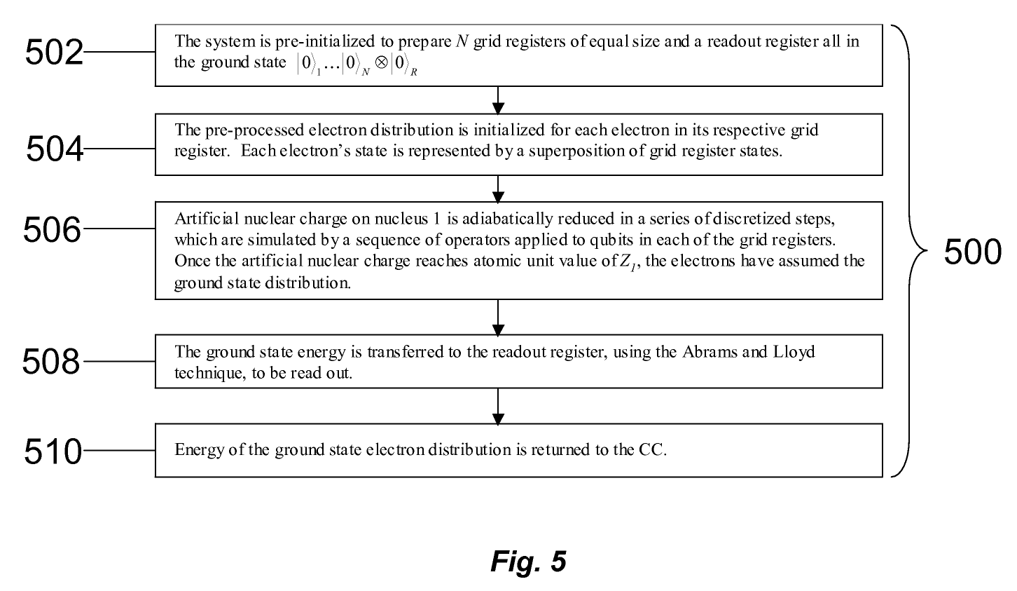

FIG. 5 illustrates the quantum algorithm for an embodiment of the present invention. FIG. 5 presents a case where one grid register is assigned to each electron, resulting in the necessity for N grid registers to carry out this aspect of the invention.

Step 502. In step 502, the system is pre-initialized to prepare N grid registers of equal size and a readout register all in the ground state |0>₁ . . . |0>_{N} [symbol] |0>_{R}.

Step 504. In step 504, the pre-processed electron distribution is initialized for each electron in its respective grid register. Each electron's state is represented by a superposition of grid register states. For example, if the grid states represent position eigenstates, and an electron is in a particular superposition of position eigenstates initially, then the grid register is prepared in that superposition of grid states corresponding to the desired superposition of position eigenstates.

Step 506. Artificial nuclear charge on nucleus one is adiabatically reduced in a series of discretized steps from a sufficiently large starting value, which are simulated by a sequence of operators applied to the qubits in each of the grid registers. Once the artificial nuclear charge reaches the atomic unit value of Z₁, the electrons have assumed the ground state distribution.

Step 508. The ground state energy is transferred to the readout register, using the Abrams and Lloyd technique, and is read out.

Step 510. In step 510, energy of the ground state electron distribution is returned to the CC. The sequence of operators of step 506 involves simulating the Hamiltonian of the molecular system with the Hamiltonian of the quantum processor. This can be realized by applying the Trotter approximation and decomposition technique to form a sequence of elementary quantum logic gates. Quantum registers capable of universal quantum computation are described in detail below. Also see, e.g., Somma et al., 2001, arXiv:quant-ph/0108146, hereby incorporated by reference in its entirety.

In some embodiments of the present invention, steps 508 and 510 for transferring and reading out the ground state energy of the system can be performed according to the Abrams and Lloyd measurement algorithm, which provides a method for reading out a ground state observable of a QM system once a ground state has been determined.

### 5.4 Exemplary Hardware Specifications

An aspect of the hybrid computer architecture is the interface between the classical computer and the quantum processor components. Since information must be exchanged between these components it is important that the resulting overhead is minimized.

In some embodiments of the present invention, the classical computer component (see FIG. 2) comprises a primary computational resource that processes the bulk of the classical algorithm and that interfaces with a classical node, where each classical node represents a specialized device for controlling a quantum processor. In such embodiments, the primary computational resource is abstracted from the details of the quantum computer. This type of configuration can help enhance the efficiency of the hybrid computer architecture.

### 5.4.1 Classical Computer

In accordance with the present invention, the classical computer is capable of implementing the hybrid algorithm, coordinating one or more quantum processors, and comparing the results for each iteration. In some embodiments, the classical computer is a grid of nodes, where the number of nodes are used to perform the classical aspects of the algorithm while some of the nodes are used to control and operate the quantum processors. In some embodiments, there is a single node that manages the algorithm and one or more separate nodes are used to interface with the one or more quantum processors. In some other embodiments, there is a single node that manages the algorithm and interfaces with the one or more quantum processors. The specific combination of nodes is chosen to optimize the computational efficiency of the architecture, by balance between parallelization of the problem versus data transfer overhead between the nodes. Classical computers useful for performing the front-end aspects are commercially available. Exemplary classical supercomputers useful for the classical component of the present invention include, but are not limited to, the Cray SX-6, X1, and XD1 (Cray Inc., Seattle Wash.) and the Hitachi SR11000 (Tokyo, Japan), and other combined vector/parallel machines. In some embodiments, vector computers, that manipulate two sets of registers rather than two registers at a time, are used.

### 5.4.2 Quantum Processor

In accordance with the present invention, the quantum computer comprises a quantum processor. In some embodiments of the present invention, the quantum computer further comprises an interface classical computer (ICC) that controls one or more quantum processors. In some embodiments ICC is a commercially available classical computer. The quantum processor is any quantum computing architecture that can perform universal quantum computation. Examples of quantum computer architectures useful for this purpose include superconducting, ion-trap, or optical quantum computers.

Methods for programming and controlling quantum computers are known. See, for example, United States Patent Publication Number 20030121028 to Coury et al., entitled “Quantum Computing Integrated Development Environment,” published Jun. 26, 2003, which is hereby incorporated by reference in its entirety.

In some embodiments of the present invention, the quantum processor is a superconducting quantum computer chip. In order for superconducting quantum computing chips to function they are placed at sufficiently low temperatures, which typically range from about 5 milliKelvin (mK) to about 80 mK. Cryogenic equipment for achieving these temperatures is well known and commercially available.

Control electronics for performing quantum logic on the superconducting quantum computer chip typically run in the room temperature environment, and other aspects of the control electronics run in the low temperature environment. In some embodiments, the use of control electronics includes application of currents and voltages to the superconducting quantum computer chip, and are generated by commercial devices and manipulated appropriately. In some embodiments, the control electronics are coordinated by the ICC, which translates machine input into machine language instructions for the superconducting quantum computer chip. The machine language is then expressed by the control electronics as currents and voltages applied to appropriate components of the superconducting quantum computer chip. Depending on the operation being performed, the currents and voltages can have direct and/or alternating components. In some cases, the alternating components have frequencies ranging from 100 megahertz (MHz) to 50 gigahertz (GHz). The currents can have magnitudes (post-filtering) ranging from 1 microampere (pA) to 1 milliampere (mA) on the actual superconducting quantum computer chip and the voltages can have magnitudes ranging from 1 picovolt (pV) to 1 millivolt (mV) on the actual superconducting quantum computer chip. The currents and voltages are sufficiently filtered and the wires are sufficiently cooled in order to be useful at the operational temperatures of the superconducting quantum computer chip. Methods for filtering and cooling these electronics are known.

Output from the superconducting quantum computer chip returns to room temperature in the form of currents or voltages, or both. These are detected by the classical computer and converted to an informational result that is returned as the output of the program.

### 5.5 Calculating the Ground State Energy of H₂ Using a Quantum Computer

In this exemplary embodiment, it is demonstrated how a quantum computer can be used to calculate the ground state energy of a hydrogen molecule efficiently in the Born-Oppenheimer approximation with fixed nuclear positions as inputs. See, for example, Sakurai, 1994, Modern Quantum Mechanics, Addison-Wesley, Reading Mass., ISBN 0201539292, hereby incorporated by reference in its entirety. The approximation, is based on the assumption that the motion of the massive nucleus, relative to the electron, can be ignored or calculated separately. This approximation does not make the method heuristic, or meta-heuristic. The quantum dynamics of the system are modeled and a ground state computed. The molecular system is subject to a common approximation, the nuclei do not move under effect of electrons, and then modeled quantum mechanically.

There are two stages to the calculation to determine the ground state energy of a hydrogen molecule. The first loads the ground state of the hydrogen molecule into a first register of the quantum computer using an adiabatic evolution technique, where the charges of the nuclei Z(t) are reduced adiabatically from Z(t=−∞)>>1 to Z(t=+∞)=+1. Once this stage is complete the algorithm of Abrams and Lloyd is applied to load the ground state energy eigenvalue into a second register of the quantum computer. The total number of qubits required is NDQ+R=25 where N (2) is the number of electrons in a hydrogen molecule, D (3) is the number of spatial dimensions (3), Q (3) is the number of qubits used to describe the spatial grid per dimension, with a total of 2³=8 grid points per dimension, or 2³⁺³⁺³=512 grid points in total, and R (7) is the number of qubits in the second (readout) register.

The strategy outlined in this example, even though it is efficient (linear in number of electrons and logarithmic in number of qubits describing the grid upon which the wavefunction evolves), is a “brute-force” approach. This strategy requires NDQ qubits in a first register, the evolution register, and R qubits in a second register, the readout register. The readout register holds the energy eigenvalue ∈₀ that is to be calculated. The number of qubits R gives the precision to which ∈₀ can be known; the error coming from finite R scales like 2^{-R}. For example, taking R=7 gives seven bits with which to write down go and therefore an error of one part in 2⁷=128.

Some specific examples to illustrate exemplary hardware levels needed to effect the quantum computations of the present exemplary embodiment will now be given. For water on a 2¹⁵ point grid, in some embodiments, N=10, D=3, and Q=5. Therefore, 150 qubits are needed for the evolution register. For such a system, a bigger readout register is needed. Assuming R=32, a total of 182 qubits are needed. For glycine, C₂H₅NO₂ on a 2³⁰ point grid, in some embodiments, N=40, D=3, and Q=10. Therefore 1200 qubits are needed for the evolution register. Assuming R=64, a total of 1,264 qubits are needed. For caffeine (102 electrons) on a 2³⁰ point grid, in some embodiments, N=102, D=3, and Q=10. Therefore 3,060 qubits are needed for the evolution register. Taking R to be 64 qubits, a total of 3,124 qubits is needed.

For a typical small molecule drug binding to a receptor site (1,000 total electrons) on a 2³⁰ point grid, in some embodiments, N=1000, D=3, and Q=10. Therefore 30,000 qubits are needed for the evolution register. Taking R to be 128 qubits, a total of 30,128 qubits is needed. Note that even if a 7:1 ratio of physical to logical qubits is required (for error correction), this last case gives about 250,000 physical qubits. If each qubit and associated hardware takes up 100 μm², this gives an area of 25 mm², which is in line with the current size of conventional microchips.

The calculation the ground state energy of H₂ involves a low mass molecular system H₂. The nomenclature for low mass systems differs from higher mass systems. For instance, the term nuclear coordinates can be used in place of atomic coordinates, and atomic mass units used in place of Daltons. Herein the terms most recognizable to a person of ordinary skill in art for the particular context are preferentially used. However, the nomenclature, herein, can be mixed. As such, as used herein, the terms atomic coordinates and nuclear coordinates are interchangeable.

### 5.5.1 Setting Up the Grid and Labeling Conventions

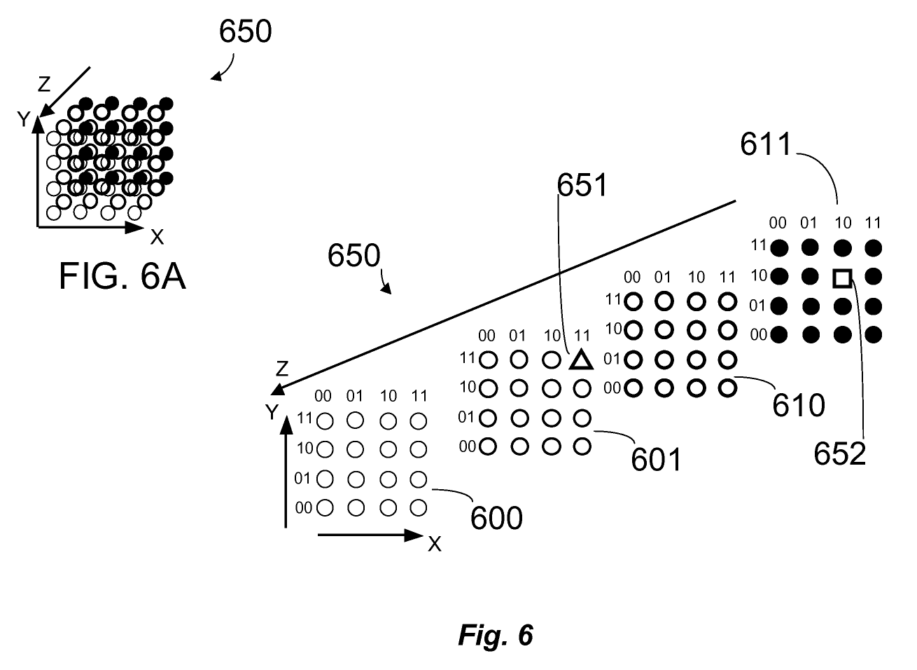

FIG. 6 illustrates a three-dimensional grid, or a subset thereof, 650 for an embodiment of the present invention. FIG. 6A shows a subset of three-dimensional space, with circles denoting points in this three-dimensional space. Each point has x, y, and z Cartesian coordinates. Each electron in the molecular system under study is assigned to a unique register of DQ qubits. D is three since there are three dimensions (x, y, and z), and Q is 2 since there are 2^{Q} grid points per dimension. In FIG. 6B grid 650 is sliced in the x-y plane and the resulting planes are drawn next to each other from left to right, with z=00, z=01, z=10, z=11, labeled by 600, 601, 610, and 611 respectively. FIG. 6B illustrates only one grid 650, with two electrons, 651 and 652, placed on this grid 650. However, each electron is represented by a grid 650. In other words, each electron can be located anywhere on the grid 650 assigned to the electron.

To explicitly see how this works, consider the case N=2, D=3, Q=2 as illustrated in FIG. 6B. The list of possible states are given in equations (1) and (2) below:
z₂−y₂−x₂−y₁−x₁ (1)
00-00-00-00-00-00 00-00-00-00-00-01 00-00-00-00-00-10 00-00-00-00-00-11 00-00-00-00-01-00 00-00-00-00-01-01 00-00-00-00-01-10 00-00-00-00-01-11 . . . . . . . . . . . . . . . . . . . . . . . . . . . . . . . . . . . . . . . . . . . . . . . . . . . 11-11-11-11-11-11 (2)

The convention used in this exemplary embodiment is that particle 1 takes up the rightmost qubits, and then electrons are added to the left.

Each possible state of the register in equation (2) corresponds to a state where electron one is at a specific point on the grid 650 (denoted by the six rightmost qubits) and electron two is at the grid point denoted by the six leftmost qubits. It covers all possible electron configurations for a two election system. For example, the register state [111010 0111111] corresponds to the situation where electron one (labeled as element 651 in FIG. 6B) is at gridpoint [011111] and electron two (labeled as 652) is at [111010] (see FIG. 6B).

### 5.5.2 Relationship Between Evolution Operators of the Molecule and the Quantum Computer

In the present exemplary embodiment, the evolution of one quantum system (the molecular system of interest) is simulated using another quantum system (the quantum computer). The following quantum computer Hamiltonian for an L-qubit quantum computer is used:

$$\hat{H} ( t ) = {\sum }_{i = 1}^{L} [ {Δ}_{x}^{( i )} ( t ) {\hat{σ}}_{x}^{( i )} + {Δ}_{y}^{( i )} ( t ) {\hat{σ}}_{y}^{( i )} + {ɛ}^{( i )} ( t ) {\hat{σ}}_{z}^{( i )} ] + {\sum }_{i < j}^{L} {J}_{ij} ( t ) {\hat{σ}}_{z}^{( i )} {\hat{σ}}_{z}^{( j )} \qquad ( 3 )$$

### 5.5.2.1 Evolution Operators in First Quantized Picture as Matrices

Because the wavefunctions are being defined on a grid in this exemplary embodiment, operators in the first quantized picture can be written as matrices. All operators that are functions only of positions \vec{r}ᵢ can be written as diagonal matrices. In each case there is an algorithm for generating the relevant matrix.

The operator xᵢ acting on the wavefunction gives the position in the x-direction of electron i.
xᵢ|Ψ>=xᵢ|Ω> (4)

For electron 1 the terms on the diagonal of operator xᵢ read [0,1,2, . . . , 2^{Q}−1] repeated 2^{Q(DN-1)} times. The operator yᵢ acting on the wavefunction gives the position in the y-direction of electron i:
yᵢ|Ψ>=yᵢ|Ω> (5)

For electron one, the terms on the diagonal of operator yᵢ read [0, . . . , 0] with 2^{Q} terms, followed by [1, . . . , 1] with 2^{Q} terms, etc. up to [2^{Q-1}, . . . , 2^{Q-1}] with 2^{Q} terms, repeated until full. The operator zᵢ acting on the wavefunction gives the position in the z-direction of electron i:
Zᵢ|Ψ>=Zᵢ|Ω> (6)

For electron one the terms on the diagonal read [0, . . . , 0]2^{2Q} terms, followed by [1, . . . , 1] with 2^{2Q} terms, etc. up to [2^{Q-1}, . . . , 2^{Q-1}] with 2^{2Q} terms.

The operator

$$\frac{1}{\vert {{r}^{->}}_{i} - {{r}^{->}}_{j} \vert}$$

acting on the wavefunction gives the Coulomb term between electron i and j:

$$\frac{1}{\vert {{r}^{->}}_{i} - {{r}^{->}}_{j} \vert} \vert ψ 〉 = \frac{1}{\vert {{r}^{->}}_{i} - {{r}^{->}}_{j} \vert} \vert ψ 〉 \qquad ( 7 )$$

The operator

$$\frac{1}{\vert {{r}^{->}}_{i} - {{R}^{->}}_{j} \vert}$$

acting on the wavefunction gives the Coulomb term between electron i and nucleus j.

$$\frac{1}{\vert {{r}^{->}}_{i} - {{R}^{->}}_{j} \vert} \vert ψ 〉 = \frac{1}{\vert {{r}^{->}}_{i} - {{R}^{->}}_{j} \vert} \vert ψ 〉 \qquad ( 8 )$$

Because all of these terms are diagonal, the evolution under these terms can be simulated efficiently with the Hamiltonian in Equation (3) by taking Δₓ=Δ_{y}=0 and varying ∈ and Jᵢⱼ in time.

### 5.5.2.2 Useful Relationships

The momentum terms \vec{p}ᵢ are not diagonal in the position representation. However, the momentum terms are diagonal in the momentum representation. It is possible to transform an operator acting in the momentum basis to an operator acting in the position basis by using the Fourier Transform operator.

Consider the operator U_{QFTγ}⁽ⁱ⁾ to be the quantum Fourier transform acting on the one-dimensional information in the y-direction of the i^{th} particle. Then, in the case of two particles in three dimensions:
U_{QFTx}⁽ⁱ⁾pᵢ^{p}^{ₓ}[U_{QFTx}⁽ⁱ⁾]^{†}=pᵢ^{x}; and
U_{QFTy}⁽ⁱ⁾pᵢ^{p}^{_{y}}[U_{QFTy}⁽ⁱ⁾]^{†}=pᵢ^{y}; and
U_{QFTz}⁽ⁱ⁾pᵢ^{p}^{_{z}}[U_{QFTz}⁽ⁱ⁾]^{†}=pᵢ^{z}.

In the notation above, we have pᵢ^{b}, where i is the electron that the momentum operator is acting on and b is the basis on which the operator is acting. The U matrices effect a transformation of the p operators from their original momentum basis defined by px, py, and pz to the positional basis defined by x, y, and z. The QFT matrices are readily obtained. See, Nielsen and Chuang, 2000, Quantum Computation and Quantum Information, pp. 204-215 as well as United States Patent Publication No. 2003/0164490 A1, to Blais, published Sep. 2, 2003, each of which is hereby incorporated by reference in its entirety.

### 5.5.3 Getting to the Ground State by Varying Nuclear Charges Adiabatically

Embodiments of the present invention include steps and/or means for adiabatically varying the parameters of the system being emulated. Embodiments of the present invention include steps for adiabatically varying the nuclear charges of the system being emulated to determine the ground state of a molecular system. These embodiments, optionally, can include using the output, a state, or the steps for varying the nuclear charges of the system being emulated as an approximate ground state of the system being emulated. Embodiments of the present invention include steps for determining input values for subsequent computation through adiabatically evolution.

As an example of step 506 of FIG. 5, consider two nuclei with charges Z₁(t) and Z₂(t) and positions \vec{R}₁=0 and \vec{R}₂=+R\hat{z}. Using Cartesian coordinates, with atomic units [symbol] =e=mₑ=1, and defining two electrons to have positions \vec{r}₁; and \vec{r}₂, the Hamiltonian is:

$$H ( t ) = \frac{{{p}^{->}}_{1}^{2}}{2} + \frac{{{p}^{->}}_{2}^{2}}{2} + \frac{1}{\vert {{r}^{->}}_{1} - {{r}^{->}}_{2} \vert} - Z ( t ) ( \frac{1}{\vert {{r}^{->}}_{1} \vert} + \frac{1}{\vert {{r}^{->}}_{1} - R \hat{z} \vert} + \frac{1}{\vert {{r}^{->}}_{2} \vert} + \frac{1}{\vert {{r}^{->}}_{2} - R \hat{z} \vert} ) \qquad ( 9 )$$

In this Hamiltonian, the (classical) Coulombic energy from the nuclear-nuclear interaction has been omitted because it is just a constant number. If, at t=−∞, when the nuclear charge is large, e.g., Z(t)>>1, the nuclear charge term dominates, then the Hamiltonian is

$$H ( t ) \approx - Z ( t ) ( \frac{1}{\vert {{r}^{->}}_{1} \vert} + \frac{1}{\vert {{r}^{->}}_{1} - R \hat{z} \vert} + \frac{1}{\vert {{r}^{->}}_{2} \vert} + \frac{1}{\vert {{r}^{->}}_{2} - R \hat{z} \vert} ) \qquad ( 10 )$$

which has solutions that can be computed efficiently. This gives the initial (known) ground state of the molecule. Now the charges on the nuclei are turned down until Z(t)=+1. After this evolution the Hamiltonian is

$$H ( t ) = \frac{{{p}^{->}}_{1}^{2}}{2} + \frac{{{p}^{->}}_{2}^{2}}{2} + \frac{1}{\vert {{r}^{->}}_{1} - {{r}^{->}}_{2} \vert} - ( \frac{1}{\vert {{r}^{->}}_{1} \vert} + \frac{1}{\vert {{r}^{->}}_{1} - R \hat{z} \vert} + \frac{1}{\vert {{r}^{->}}_{2} \vert} + \frac{1}{\vert {{r}^{->}}_{2} - R \hat{z} \vert} ) \qquad ( 11 )$$

If Z(t) was turned down adiabatically and the system started off in the ground state of (10) then the system will be in the ground state of (11) after Z →+1.

A specific example of a function Z(t) is

$$Z ( t ) = \frac{{Z}_{0}}{2} [ 1 - tanh ( Ω t ) ] + 1 \qquad ( 12 )$$

where Z₀ and Ω describe how quickly the nuclear charges are ramped down to +1.

Because it has been shown in this example that all of the terms in (9) can be simulated efficiently with the quantum computer Hamiltonian (3), it follows that the adiabatic evolution described here can be simulated efficiently with the quantum computer of the present invention.

### 5.5.3.1 Using the Trotter Decomposition to Perform the Adiabatic Step with the Quantum Computer

The conceptual idea of the Trotter decomposition is to slice up a Hamiltonian into small time steps, and apply each “slice” in order. See, Nielsen and Chuang, 2000, Quantum Computation and Quantum Information, pp. 204-215, which is hereby incorporated by reference in its entirety. The Trotter decomposition is used as follows
|Ψ(t=+∞)>≧Û(−∞,+∞)Ψ(t=−∞)> (13)
|Ψ(t=+nΔt)>≧Û(−nΔt,+nΔt)Ψ(t=−nΔt)>> (14)
|Ψ(t=+nΔt)>≧\hat{V}[(n−1)Δt, nΔt]\hat{V}[(n−2)Δt, (n−1)Δt]· . . . ·\hat{V}[−nΔt,−(n−1)Δt]Ψ(t=−nΔt)> (15)
where the evolution operators V are the Trotter decompositions of the actual evolution operators in each timeslice; and

$$\begin{matrix}{V}^{->} [ ( j - 1 ) Δ t , j Δ t ] = exp [ ⅈ \frac{Δ t}{2} {H}_{0} ( {r}^{->} , j Δ t ) ] \cdot exp [ ⅈ Δ t {H}_{1} ( {p}^{->} ) ] \cdot exp [ ⅈ \frac{Δ t}{2} {H}_{0} ( {r}^{->} , j Δ t ) ] . & ( 16 )\end{matrix}$$

### 5.5.4 Extracting ground state energy to readout register

Once the system stabilizes into |Ψ_{GS}>≈|t=+nΔt> that state is used as the state |Vₐ> in the Abrams and Lloyd algorithm, as described by Abrams and Lloyd, 1999, Phys. Rev. Lett., 83, pp. 5162-5165, which is hereby incorporated by reference, where

$$\vert {V}_{a} 〉 = {\sum }_{k} {c}_{k} \vert {ϕ}_{k} 〉$$

in this case since the system should be in the ground state |Vₐ>≈|φ₀>. The algorithm of Abrams and Lloyd is an example of an eigenvalue finding algorithm. The algorithm begins by considering a quantum computer with two registers containing R and NDQ qubits respectively. These two registers serve two different purposes in this algorithm. The R qubit register is used to do a quantum Fourier transform and read out the desired energy eigenvalue at the end of the computation. Herein, the R qubit register is also called the readout register. The NDQ qubit register encodes the Hilbert space in which the quantum evolution operator U=exp(itH_{final}) acts. The Hamiltonian used here is the t→∞ version, after the system has settled into its ground state and is not explicitly time dependent anymore. Herein, the NDQ qubit register is also called the evolution register.

The eigenvalues of H_{final} are extracted by measuring the state of the R qubit register. Since there are Γ=2^{R} possible states in this register, the accuracy of the result scales as 1/Γ. The size of register R is not a function of the size of the molecular system being simulated because it is an “output method” whose size is chosen based on the accuracy desired for the answer.

The algorithm in accordance with this embodiment of the invention proceeds as described below. This description is one embodiment of step 508 of FIG. 5, other embodiments may vary or omit steps.

Step 1. Initialization. First, all R qubits are initialized into state |0>. Second, the NDQ qubit register is initialized into the |Ψ_{GS}> state using the adiabatic technique described in step 506 of FIG. 5, and Section 5.5.3.1. This gives the “initial” state of the simulation
|φ>−|0> [symbol] |Ψ_{GS}> (17)
where the two registers are R (left) and NDQ (right). If the input wave function |Ψ_{GS}> is not already antisymmetrized, one can use the algorithms described in Section 5.5.5 to do so.

Step 2. Rotation of the readout register qubits. Next, a π/2 rotation is performed on each of the R qubits. This can be done by applying a \hat{σ}ₓ pulse of area π/2 to each of the R qubits in parallel. This transforms the system state to

$$\vert Φ 〉 = \frac{1}{\sqrt{Γ }} {\sum }_{j = 0}^{Γ - 1} \vert j 〉 ⊗ \vert {Ψ}_{G S} 〉 \qquad ( 18 )$$

where the notation is that |j> is the state corresponding to the binary value j.

Step 3. Evolve the system with Û in a specific way. Next the quantum evolution operator is used to create the state

$$\vert Φ 〉 = \frac{1}{\sqrt{Γ}} {\sum }_{j = 0}^{Γ - 1} \vert j 〉 ⊗ {( \hat{U} )}^{j} \vert 0 〉 \qquad ( 19 )$$

This transformation is accomplished by applying the operation Û to the NDQ qubit register j times.

Step 4. Perform a quantum Fourier transform on the R qubit register. In order to see why this works, the state of the system is rewritten. First, label the exact eigenvectors of Û, which are unknown, by states |Ψ_{GS}> and the corresponding eigenvalues λₖ. Then the initial state can be written

$$\vert {Ψ}_{G S} 〉 = {\sum }_{k} {c}_{k} \vert {ψ}_{k} 〉 ∼ \vert {ψ}_{0} 〉 \qquad ( 20 )$$

Using this relationship, the state can be rewritten as

$$\begin{matrix}\vert Φ 〉 = \frac{1}{\sqrt{Γ }} {\sum \vert}_{j = 0}^{Γ - 1 \vert} j 〉 ⊗ {( \hat{U} )}^{i} {\sum }_{k} {c}_{k} \vert {ψ}_{k} 〉 = \frac{1}{ \sqrt{Γ}} {\sum }_{k} {c}_{k} {\sum }_{j = 0}^{ Γ - 1} \vert j 〉 ⊗ {( {λ}_{ k} )}^{j} \vert {ψ}_{k} 〉 & ( 21 )\end{matrix}$$

We now write μₖ4=e^{iωk} and move it over so that it is in front of the R qubit register (these are just numbers so this can done), giving

$$\vert Φ 〉 = \frac{1}{\sqrt{Γ}} {\sum }_{k} {c}_{k} {\sum }_{j = 0}^{Γ - 1} {ⅇ}^{ⅈ {ω }_{k} k} \vert j 〉 ⊗ \vert {ψ}_{k} 〉 \qquad ( 22 )$$

The quantum Fourier transform acts as

$$F \text{:} j 〉 -> \frac{1}{\sqrt{Γ}} {\sum }_{y = 0}^{Γ - 1} {ⅇ}^{2 π ⅈj y / Γ} \vert y 〉 \qquad ( 23 )$$

Inserting this into (22) gives

$$\vert Φ 〉 = \frac{1}{\sqrt{Γ}} {\sum }_{k} {c}_{k} {\sum }_{j = 0}^{Γ - 1} {ⅇ}^{{ⅈω}_{k} j} \frac{1}{\sqrt{Γ}} {\sum }_{y = 0}^{Γ - 1} {ⅇ}^{2 π ⅈjy / Γ} \vert y 〉 ⊗ \vert {ψ}_{k} 〉 \qquad ( 24 )$$

Rewriting this as

$$\vert Φ 〉 = \frac{1}{Γ} {\sum }_{k} {c}_{k} \{ {\sum }_{j = 0}^{Γ - 1} exp [ \frac{2 π ⅈj}{Γ} ( y + \frac{{ω}_{k} Γ}{2 π} ) ] \} \vert y 〉 ⊗ \vert {ϕ}_{k} 〉 \qquad ( 25 )$$

it is noted that the term in the square brackets will be sharply peaked at y=−ωₖΓ/2π. This means that if the R qubit register is now measured, the most probable state of the system corresponds to eigenvalues of H_{final}. The quantum Fourier transform causes destructive interference between incorrect states, and constructive interference for the states wanted. Knowing |y>, and therefore the number y, ωₖ can be calculated.

Step 5. Measure the state of the R qubit register. A measurement on this register selects one of the |y> states, which will be the k^{th} eigenvalue with probability |cₖ|². Denoting the state measures as |\tilde{y}>, after the measurement the system state becomes

$$\vert Φ 〉 = \frac{1}{Γ} {\sum }_{k} {c}_{k} \{ {\sum }_{j = 0}^{Γ - 1} exp [ \frac{2 πⅈj}{Γ} ( \tilde{y} + \frac{{ω}_{k} Γ}{2 π} ) ] \} \vert \tilde{y} 〉 ⊗ \vert {ϕ}_{k} 〉 \qquad ( 26 )$$

This is sharply peaked at the value of k corresponding to ωₖ=−2π\tilde{y}/Γ, allowing one to write
|φ>∞|\tilde{y}> [symbol] |\tilde{ψ}ₖ> (27)
where now the NDQ qubit register is in the eigenvector corresponding to the Eigenvalue ωₖ just measured, which should be the ground state ω₀ because of the adiabatic step at the beginning.

Note that the closer the initially chosen state is to the exact ground state, the closer |cₒ|² will be to one. In other words, the more likely it will be that the result of measuring the readout register will give the ground state eigenvalue.

### 5.5.5 General Procedure for Antisymmetrization

In order to accommodate fermions in simulations of many-body Fermi systems on a universal quantum computer, an efficient quantum algorithm for antisymmetrization is needed. Such an algorithms are known. See, for example, Abrams, and Lloyd, 1997, Physical Review Letters 79, pp. 2587-2859; or Somborger and Stewart, 1999, Physical Review A 60, pp. 1956-1965, each of which is hereby incorporated by reference in its entirety. When the state is antisymmetrized, the emulation of time evolution on the quantum computer is straightforward. The Hamiltonian is split into a sum of terms (Hᵢ) and the corresponding time evolution operators are applied to the states in series. The time evolution operators are Uᵢ=exp[(i/ [symbol] )(t/n)Hᵢ]. Antisymmetrization is accomplished in four main steps described below.

Step I. Initialization of the input state. The user defines three registers A, B, and C, each consisting of n quwords. A quword is a string of qubits of length log₂m; where one quword represents any integer in the range 1, . . . , m and, consequently, the state of one particle; hence n quwords are n log₂ m qubits. The qubits in register A are initialized to the unsymmetrized input state |Ψ>. The algorithm is unaffected if this state is a superposition of several ordered n-tuples. The correspondence between an ordered n-tuple of quwords and an antisymmetrized superposition is one to one.

Step II: Generating n! states. The user creates the following state in register B:

$$\frac{1}{n !} ( {\sum }_{i = 1}^{n} \vert i 〉 ) ⊗ ( {\sum }_{i = 1}^{n - 1} \vert i 〉 ) ⊗ ( {\sum }_{i = 1}^{n - 2} \vert i 〉 ) ⊗ ⋯ ⊗ ( \vert 2 〉 + \vert 1 〉 ) ⊗ ( \vert 1 〉 ) \qquad ( 28 )$$

This is accomplished with order n(ln m)² steps by performing appropriate rotations on each qubit, one at a time. For example, if the number 8 is encoded in the register as |000>, the state

$${\sum }_{i = 1}^{3} \vert i 〉$$

is generated by rotating each of the three qubits into the state |0>+|1>. The states

$${\sum }_{i = 1}^{j} \vert i 〉$$

for cases of j where it is not a power of two (j≠2ⁱ) can be generated in a similar manner by using controlled rotations that are conditioned on previous qubits.

Step III: Transform into permutations of natural numbers. The goal of this third step is to transform register B into the state

$$\frac{1}{n !} ( {\sum }_{σ ∈ {S}_{n}}^{n} \vert σ ( 1 , … , n ) 〉 ) \qquad ( 29 )$$

where Sₙ is the symmetric group of permutations on n objects. A permutation of a plurality of objects is a “shuffling” of them, that is, the objects exchange places with each other. Shuffling a deck of cards permutes their order. There are n! permutations on a group of n objects. Since there are n possible choices for the first position and for each of these there are n−1 choices for the second position and for each of these n(n−1) ways of choosing the first two there are n−2 ways of choosing the object for the third position, etc.

The state of register B is now an equal superposition of the states representing all the permutations of the first n natural numbers. This can be done in the following manner. Let B[i] indicate the i^{th} quword in register B; then map B[i] into a quword B′[i] by setting B′[1]=B[1], and B′[i] equal to the B[i]^{th} natural number that is not contained in the set {B′[i], . . . , B′[i−1]}, for i>1. This transformation is effected with about n²ln m operations.

To prepare for the fourth step of the algorithm the n-tuple 1, 2, 3, . . . , n is then assigned to register C, leaving the computer in the state (A [symbol] B [symbol] C):

$$\frac{1}{n !} \vert Ψ 〉 ⊗ ( {\sum }_{σ ∈ {S}_{n}}^{n} \vert σ ( 1 , … , n ) 〉 ) ⊗ \vert 1 , … , n 〉 . \qquad ( 30 )$$

Step IV. Sorting and unsorting. The algorithm for antisymmetrization proceeds with a series of sorting and unsorting operations. A string of “scratch” qubits is required so that the sorting operations are reversible. Any sorting algorithm can be used. An exemplary sort is Heap sort, because it requires about n ln n operations in all cases and only n log₂ n scratch qubits. The first sort orders register B with a series of exchanges and scrambles A and C with the same series of exchanges. There it is exactly known how registers A and C are scrambled. At this point, one has already obtained a symmetrized superposition of the input states, but it is entangled with many other qubits. One can antisymmetrize by counting the number of exchanges made during the sorting operation and advancing the phase of that component of the superposition by π if this number is odd. For Bosons, all that has to be done is simply leave the symmetrized state as is and proceed. The algorithm continues by reversing the sort on register B, but leaving registers A and C unchanged.

The qubits contained in registers B and C are then redundant. In each component of the superposition, if B[i]=n, then C[n]=i. This redundancy allows B to be set to zero reversibly. By then sorting A and C together, eliminating C, and unsorting, the user obtains the desired antisymmetrized state. Note that in the final unsorting operation, the algorithm relies upon the fact that the ordering of the input state |Ψ> was stipulated to be the same as the ordering of the integers 1, . . . , n in register C so that antisymmetrization would be reversible. If this were not the case, the algorithm would fail. The entire process, steps I-IV, is completed in about n² (ln m)² operations.

### 6. CONCLUSION

All references cited herein are incorporated herein by reference in their entirety and for all purposes to the same extent as if each individual publication, patent, patent application, or patent publication was specifically and individually indicated to be incorporated by reference in its entirety for all purposes.

When introducing elements of the present invention or the embodiment(s) thereof, the articles “a,” “an,” “the,” and “said” are intended to mean that there are one or more of the elements. The terms “comprising,” “including,” and “having” are intended to be inclusive and to mean that there may be additional elements other than the listed elements. Moreover, the term “about” has been used to describe specific parameters. In many instances, specific ranges for the term “about” have been provided. However, when no specific range has been provided for a particular usage of the term “about” herein, than either of two definitions can be used. In the first definition, the term “about” is the typical range of values about the stated value that one of skill in the art would expect for the physical parameter represented by the stated value. For example, a typical range of values about a specified value can be defined as the typical error that would be expected in measuring or observing the physical parameter that the specified value represents. In the second definition of about, the term “about” means the stated value±0.10 of the stated value.

The present invention can be implemented as a computer program product that comprises a computer program mechanism embedded in a computer readable storage medium. For instance, the computer program product could contain the program modules shown in FIG. 7 (e.g., the refinement coordination program). Furthermore, the computer program product could contain program modules that encode any of the algorithms or methods disclosed herein. These program modules can be stored on a CD-ROM, DVD, magnetic disk storage product, or any other computer readable data or program storage product. The software modules in the computer program product can also be distributed electronically, via the Internet or otherwise, by transmission of a computer data signal (in which the software modules are embedded) either digitally or on a carrier wave.

While the present invention has been described with reference to a few specific embodiments, the description is illustrative of the invention and is not to be construed as limiting the invention. Various modifications may occur to those skilled in the art without departing from the true spirit and scope of the invention as defined by the appended claims. This patent specification concludes with the appended claims.

We claim:

1. A method of simulating a molecular system for use on a hybrid system, wherein the hybrid system comprises a classical computer and a quantum computer, the method comprising:
(A) sending an input from the classical computer to the quantum computer, wherein the input comprises a set of atomic coordinates \vec{R}ₙ of the molecular system and a set of atomic charges Zₙ for the set of atomic coordinates;
(B) determining, using the quantum computer, a ground state energy of the molecular system based on the input set of atomic coordinates;
(C) returning the ground state energy of the molecular system to the classical computer;
(D) optimizing the set of atomic coordinates based on information about the ground state energy of the molecular system provided in step (C) thereby producing a new set of atomic coordinates \vec{R}′ₙ for the molecular system; and
(E) repeating steps (A) through (D), wherein the new set of atomic coordinates \vec{R}′ₙ from a previous instance of step (D) becomes the set of atomic coordinates \vec{R}ₙ used in repeated step (A), until a predetermined termination condition is reached.

2. The method of claim 1, wherein the ground state energy of the molecular system returned to the classical computer in step (C) is represented by a binary number.

3. The method of claim 1, wherein the input further comprises a number specifying a number of electrons N in the molecular system.

4. The method of claim 1 wherein the input further comprises a set of one or more parameters of the molecular system.

5. The method of claim 4, wherein the set of one or more parameters comprises a set of ground state atomic coordinates of the molecular system and a ground state energy of the molecular system as determined by the quantum computer at a time prior to implementation of step (A).

6. The method of claim 1, wherein the quantum computer comprises a superconducting quantum processor.

7. The method of claim 1, further comprising:
(F) sending a final set of atomic coordinates from the classical computer to the quantum computer, along with a parameter U of the molecular system for which a quantum calculation is sought; and
(G) causing the quantum computer to solve for U and return an output to the classical computer.

8. The method of claim 7 wherein steps (F) and (G) are repeated once for each parameter U in a plurality of parameters U.

9. The method of claim 1, wherein the predetermined termination condition is any combination of:
(i) a time when the ground state energy of the molecular system falls below a specified value;
(ii) a predetermined number of repetitions of steps (A) through (D);
(iii) a time when a natural ground state of the molecular system has been reached;
(iv) the atomic coordinates of a natural ground state of the molecular system has been reached within a predetermined accuracy; and
(v) the achievement of a predetermined condition of a general optimization algorithm run on the classical computer.

10. The method of claim 2, wherein the binary number comprises R bits selected to minimize an error in the ground state energy according to the following formula:
E=Eₒ2^{-R}
where E is the error in the calculated ground state energy, and E₀ is an empirical constant.

11. The method of claim 7, wherein the input further comprises a request for the calculation of an unknown value and the output further comprises a particular value of the unknown value.

12. The method of claim 11, wherein the output further comprises an updated value for an additional output parameter for the molecular system.

13. The method of claim 1, wherein said molecular system comprises a first molecule and a second molecule, and wherein the second molecule is noncovalently bound to the first molecule.

14. The method of claim 13, wherein the set of atomic coordinates \vec{R}ₙ of the molecular system comprises atomic coordinates for the first molecule and wherein the atomic coordinates for the first molecule have been experimentally determined.

15. The method of claim 14, wherein the atomic coordinates for the first molecule in said set of atomic coordinates \vec{R}ₙ of the molecular system have been determined by X-ray crystallography, nuclear magnetic resonance, or mass spectrometry.

16. The method of claim 13, wherein the first molecule is a protein having a molecular weight of 1000 Daltons or greater.

17. The method of claim 16, wherein the second molecule binds to the first molecule thereby inhibiting an enzymatic activity associated with said first molecule.

18. A method of determining a ground state energy of a molecular system comprising:
determining an initial electron distribution of a plurality of electrons in the molecular system based on a set of atomic coordinates for the molecular system wherein a nuclear charge of a first nucleus in the set of atomic coordinates is set to a large magnitude such that all of the electrons in the plurality of electrons are localized around the first nucleus;
assigning each respective electron in the plurality of electrons to a corresponding grid register in a plurality of grid registers;
initializing each respective electron in the plurality of electrons in its corresponding grid register according to the initial electron distribution;
adiabatically reducing the nuclear charge on the first nucleus in a series of steps until the first nucleus has reached a natural charge value, wherein the reduction is simulated by a sequence of operators applied to qubits in each of the grid registers in the plurality of grid registers;
computing the ground state energy of the molecular system using an Eigenvalue finding algorithm; and
transferring the ground state energy of the molecular system to a readout register using a measurement algorithm.

19. The method of claim 18, wherein the initializing step comprises representing a state of an electron in the plurality of electrons by a superposition of grid register states for the grid register corresponding to the electron.

20. The method of claim 19, wherein the plurality of grid registers are of equal size.

21. The method of claim 18, wherein the initializing step includes initializing the readout register in a ground state.

22. The method of claim 18, wherein the transferring step further comprises providing a ground state electron distribution energy to the readout register.

23. The method of claim 18, wherein the plurality of grid registers and the readout register are comprised of superconducting qubits.

24. The method of claim 18, wherein said initializing step causes a grid register in the plurality of grid registers to encode an eigenstate of a corresponding electron in the plurality of electrons.

25. The method of claim 24, wherein the eigenstate is a position eigenstate.

26. A computer program product for use in conjunction with a classical computer system, the computer program product comprising a computer readable storage medium and a computer program mechanism embedded therein, the computer program mechanism for simulating a molecular system, the computer program mechanism comprising:
(A) instructions for sending an input from the classical computer system to a quantum computer, wherein the input comprises a set of atomic coordinates \vec{R}ₙ of the molecular system and a set of atomic charges Zₙ for the set of atomic coordinates;
(B) instructions for determining, using the quantum computer, a ground state energy of the molecular system based on the input set of atomic coordinates;
(C) instructions for receiving the ground state energy of the molecular system from the quantum computer;
(D) instructions for optimizing the set of atomic coordinates based on information about the ground state energy of the molecular system provided by said instructions for receiving (C) thereby producing a new set of atomic coordinates \vec{R}′ₙ for said molecular system; and
(E) instructions for repeating instructions (A) through (D), wherein the new set of atomic coordinates \vec{R}′ₙ from the last instance of said instructions for optimizing (D) become the set of atomic coordinates \vec{R}ₙ used in the repeated instructions for sending (A), until a predetermined termination condition is reached.

27. The computer program product of claim 26, wherein the ground state energy of the molecular system returned to the classical computer system by said instructions for receiving (C) are represented by a binary number.

28. The computer program product of claim 26, wherein the input further comprises a number specifying a number of electrons N in the molecular system.

29. The computer program product of claim 26, wherein the computer program mechanism further comprises:
(F) instructions for sending a final set of atomic coordinates from the classical computer system to the quantum computer, along with a parameter U of the molecular system for which a quantum calculation is sought; and
(G) instructions for causing the quantum computer to solve for U and return an output to the classical computer system.

30. The computer program product of claim 29, wherein instructions (F) and (G) are repeated once for each parameter U in a plurality of parameters U.

31. The computer program product of claim 26, wherein the predetermined termination condition is any combination of:
(i) a time when the ground state energy of the molecular system falls below a specified value;
(ii) a predetermined number of repetitions of steps (A) through (D);
(iii) a time when a natural ground state of the molecular system has been reached;
(iv) the atomic coordinates of a natural ground state of the molecular system has been reached within a predetermined accuracy; and
(v) the achievement of a predetermined condition of a general optimization algorithm run on the classical computer system.

32. The computer program product of claim 27, wherein the binary number comprises R bits selected to minimize an error in the ground state energy according to the following formula:
E=Eₒ2^{-R}
wherein E is the error in the calculated ground state energy, and E₀ is an empirical constant.

33. The computer program product of claim 26, wherein said molecular system comprises a first molecule and a second molecule, and wherein the second molecule is noncovalently bound to the first molecule.

34. The computer program product of claim 33, wherein the set of atomic coordinates \vec{R}ₙ of the molecular system comprises atomic coordinates for the first molecule and wherein the atomic coordinates for the first molecule have been experimentally determined.

35. The computer program product of claim 34, wherein the atomic coordinates for the first molecule in the set of atomic coordinates \vec{R}ₙ of the molecular system have been determined by X-ray crystallography, nuclear magnetic resonance, or mass spectrometry.

36. The computer program product of claim 33, wherein the first molecule is a protein having a molecular weight of 1000 Daltons or greater.

37. The computer program product of claim 36, wherein the second molecule binds to the first molecule thereby inhibiting an enzymatic activity associated with said first molecule.

38. A computer program product for use in conjunction with a classical computer system, the computer program product comprising a computer readable storage medium and a computer program mechanism embedded therein, the computer program mechanism for determining a ground state energy of a molecular system, the computer program mechanism comprising:
instructions for determining an initial electron distribution of a plurality of electrons in the molecular system based on a set of atomic coordinates for the molecular system wherein a nuclear charge of a first nucleus in the set of atomic coordinates is set to a large magnitude such that all of the electrons in the plurality of electrons are localized around the first nucleus;
instructions for assigning each respective electron in the plurality of electrons to a corresponding grid register in a plurality of grid registers;
instructions for initializing each respective electron in the plurality of electrons in its corresponding grid register according to the initial electron distribution;
instructions for adiabatically reducing the nuclear charge on the first nucleus in a series of steps until the first nucleus has reached a natural charge value, wherein the reduction is simulated by a sequence of operators applied to qubits in each of the grid registers in the plurality of grid registers;
instructions for computing the ground state energy of the molecular system using an Eigenvalue finding algorithm; and
instructions for transferring the ground state energy of the molecular system to a readout register using a measurement algorithm.

39. A method of calculating an energy of a molecular system, comprising:
(A) initializing a plurality of qubits, wherein the plurality of qubits comprises a set of readout qubits and a set of evolution qubits;
each qubit in the plurality of qubits has a state, the set of readout qubits is initialized in a vacuum state; and
the set of evolution qubits is initialized in a predetermined state;
(B) rotating a state of each qubit in the set of readout qubits by an angle of about π/2 radians around the x-axis;
(C) evolving the set of evolution qubits with a unitary operator;
(D) performing a quantum Fourier transform on the set of readout qubits; and
(E) measuring the set of readout qubits.

40. The method of claim 39, wherein, in said initializing step, the predetermined state of the set of evolution qubits is computed by a step for determining the predetermined state.

41. The method of claim 39, wherein said rotating step comprises applying a plurality of \hat{σ}ₓ pulses, each of area π/2, to each of the qubits in the set of readout qubits.

42. The method of claim 41, wherein the plurality of pulses are applied in parallel or in series.

43. The method of claim 39, wherein the initializing step occurs before the rotating step.

44. The method of claim 39, wherein the steps occur in the order specified.

45. The method of claim 39, wherein said rotating step transforms the state of a qubit in the plurality of qubits from a first state:

|0> [symbol] |Ψ_{GS}>
to a second state:
$$\frac{1}{\sqrt{Γ}} {\sum }_{j = 0}^{Γ - 1} \vert j 〉 ⊗ \vert {Ψ}_{GS} 〉 ,$$
where |j> is a state corresponding to a binary value j and Γ is a natural number.

46. The method of claim 39, wherein said evolving step comprises repeatedly applying a second unitary operator Û to the set of evolution qubits.

47. The method of claim 39, wherein the unitary operator is time independent.

48. The method of claim 39, wherein the quantum Fourier transform causes interference between states of the qubits in the set of readout qubits.

49. The method of claim 39, wherein the readout step includes measuring the state of the set of readout qubits.

50. The method of claim 39, wherein the readout step comprises computing an Eigenvalue encoded in the state of the readout qubits, and the Eigenvalue corresponds to an eigenvector stored in the set of evolution qubits after the measuring step.

51. The method of claim 39, wherein the state of the set of evolution qubits is an eigenvector corresponding to an Eigenvalue just measured in the state of the set of readout qubits.

52. The method of claim 51, wherein the Eigenvalue is a ground state of the molecular system being emulated.

53. The method of claim 39, wherein the predetermined state is an approximate ground state of the molecular system being emulated.

54. A method of calculating an energy of a molecular system, comprising:
initializing a plurality of qubits, wherein the plurality of qubits comprises a set of readout qubits in a first predetermined state and a set of evolution qubits in a second predetermined state, wherein the second predetermined state is computed by adiabatically varying a magnitude of a set of nuclear charges in the molecular system and the second predetermined state is a quantum state of the molecular system; and
computing an energy of the second predetermined state by performing an Eigenvalue finding algorithm on the plurality of qubits.

55. The method of claim 54, wherein the Eigenvalue finding algorithm comprises:
applying a plurality of ax pulses each of area about π/2 to each qubit in the set of readout qubits;
evolving the set of evolution qubits with repeated application of a time independent operator;
performing a quantum Fourier transform on the set of readout qubits; and
measuring a state of the set of readout qubits.

56. The method of claim 54, wherein the first predetermined state is a vacuum state.
